(19) United States
(12) Patent Application Publication
(10) Pub. No.: US 2012/0089579 A1
(43) Pub. Date: Apr. 12, 2012

(54) COMPRESSION PIPELINE FOR STORING DATA IN A STORAGE CLOUD

(76) Inventors: Sandeep Ranade, San Jose, CA (US); Allen Samuels, San Jose, CA (US)

(21) Appl. No.: 12/901,385

(22) Filed: Oct. 8, 2010

(51) Int. Cl. G06F 17/00

(52) U.S. Cl. 707/693; 707/E17.01

(57) ABSTRACT

A cloud storage appliance separates a point-in-time copy of a storage system into payload data chunks and metadata data chunks. The cloud storage appliance identifies a plurality of payload data chunks that have not been saved to a storage cloud. The cloud storage appliance compresses the plurality of payload data chunks. The cloud storage appliance groups the plurality of compressed payload data chunks into one or more cloud files, wherein each of the one or more cloud files is formatted for storage on the storage cloud. The cloud storage appliance then sends the one or more cloud files to the storage cloud.

### RELATED APPLICATIONS

The present application is related to co-filed U.S. patent application Ser. No. ______ entitled “METHOD AND APPARATUS FOR SELECTING REFERENCES TO USE IN DATA COMPRESSION” (attorney docket number 8747P007), filed ______, which is assigned to the assignee of the present application.

### TECHNICAL FIELD

Embodiments of the present invention relate to data storage, and more specifically to a compression pipeline that compresses data before sending the data to a storage cloud for storage.

### BACKGROUND

Enterprises typically include expensive collections of network storage, including storage area network (SAN) products and network attached storage (NAS) products. As an enterprise grows, the amount of storage that the enterprise must maintain also grows. Thus, enterprises are continually purchasing new storage equipment to meet their growing storage needs. However, such storage equipment is typically very costly. Moreover, an enterprise has to predict how much storage capacity will be needed, and plan accordingly.

Cloud storage has recently developed as a storage option. Cloud storage is a service in which storage resources are provided on an as needed basis, typically over the internet. With cloud storage, a purchaser only pays for the amount of storage that is actually used. Therefore, the purchaser does not have to predict how much storage capacity is necessary. Nor does the purchaser need to make up front capital expenditures for new network storage devices. Thus, cloud storage is typically much cheaper than purchasing network devices and setting up network storage.

Despite the advantages of cloud storage, enterprises are reluctant to adopt cloud storage as a replacement to their network storage systems due to its disadvantages. First, most cloud storage uses completely different semantics and protocols than have been developed for file systems. For example, network storage protocols include common internet file system (CIFS) and network file system (NFS), while protocols used for cloud storage include hypertext transport protocol (HTTP) and simple object access protocol (SOAP). Additionally, cloud storage does not provide any file locking operations, nor does it guarantee immediate consistency between different file versions. Therefore, multiple copies of a file may reside in the cloud, and clients may unknowingly receive old copies. Additionally, storing data to and reading data from the cloud is typically considerably slower than reading from and writing to a local network storage device.

Cloud storage protocols also have different semantics to block-oriented storage, whether network block-storage like iSCSI, or conventional block-storage (e.g., SAN or DAS). Block-storage devices provide atomic reads or writes of a contiguous linear range of fixed-sized blocks. Each such write happens “atomically” with request to subsequent read or write requests. Allowable block ranges for a single block-storage command from one block up to several thousand blocks. In contrast, cloud-storage objects must each be written or read individually, with no guarantees, or at beast weak guarantees, of consistency of subsequent read requests which read some or all of a sequence of writes to cloud-storage objects. Finally, cloud security models are incompatible with existing enterprise security models. Embodiments of the present invention combine the advantages of network storage devices and the advantages of cloud storage while mitigating the disadvantages of both.

### SUMMARY

Described herein are a method and apparatus for converting a snapshot into a collection of cloud files, each of which includes multiple compressed data chunks. In one embodiment, a cloud storage appliance separates a point-in-time copy of a storage system into payload data chunks and metadata data chunks. The cloud storage appliance identifies payload data chunks that have not been saved to a storage cloud. The cloud storage appliance compresses the plurality of payload data chunks. The cloud storage appliance groups the plurality of compressed payload data chunks into one or more cloud files, wherein each of the one or more cloud files is formatted for storage on the storage cloud. The cloud storage appliance then sends the one or more cloud files to the storage cloud. Once all of the payload data chunks have been compressed and sent to the storage cloud, the metadata data chunks may be compressed, added to cloud files, and sent to the storage cloud.

The cloud file may have a maximum size and a maximum number of compressed data chunks that it can include. In one embodiment, compressed data chunks are added to the cloud file until it reaches the maximum size or the maximum number of compressed data chunks. Formatting the cloud file may include adding a directory to the cloud file that identifies where in the cloud file each of the included compressed data chunks is located. Formatting the cloud file may also include adding a header to the cloud file that identifies where in the cloud file the directory can be located and adding a descriptor to the cloud file that identifies all data chunks referenced by compressed data chunks in the cloud file.

### BRIEF DESCRIPTION OF THE DRAWINGS

The present invention is illustrated by way of example, and not by way of limitation, in the figures of the accompanying drawings and in which:

FIG. 1 illustrates an exemplary network architecture, in which embodiments of the present invention may operate;

FIG. 2 illustrates an exemplary network architecture, in which multiple cloud storage appliances and a cloud storage agent are used at different locations, in accordance with one embodiment of the present invention;

FIG. 3 illustrates a block diagram of a cloud storage appliance, in accordance with one embodiment of the present invention;

FIG. 4A illustrates a block diagram of a compression pipeline, in accordance with one embodiment of the present invention;

FIG. 4B illustrates one embodiment of the contents of queues in a compression pipeline;

FIG. 4C diagrammatically shows a reference tree for a compressed data chunk;

FIG. 5 illustrates one embodiment of a reference fetcher;

FIG. 6A illustrates an offset example, in which the contents of a data chunk match portions of two sequential reference chunks;

FIG. 6B illustrates another offset example, in which the contents of a reference chunk match portions of two sequential data chunks;

FIG. 7A is a block diagram showing an example data chunk and example bitmaps, according to one embodiment of the present invention;

FIG. 7B illustrates reference chunk pair bitmaps generated from reference chunk bitmaps of FIG. 7A;

FIG. 7C is a block diagram showing an example data chunk and example bitmaps, according to one embodiment of the present invention;

FIG. 8A illustrates a probability distribution for matching between a data chunk and a reference chunk;

FIG. 8B illustrates a probability distribution generated from a reference chunk pair bitmap;

FIG. 9 is a flow diagram illustrating one embodiment of a method for converting a snapshot into compressed data chunks;

FIG. 10A is a flow diagram illustrating one embodiment of a method for selecting optimal reference chunks to use for compressing a data chunk;

FIG. 10B is a flow diagram illustrating another embodiment of a method for selecting optimal reference chunks to use for compressing multiple data chunks;

FIG. 10C is a flow diagram illustrating still another embodiment of a method for selecting optimal reference chunks to use for compressing one or more data chunks;

FIG. 11A is a flow diagram illustrating yet another embodiment of a method for selecting optimal reference chunks to use for compressing a data chunk;

FIG. 11B is a flow diagram illustrating one embodiment of a method for compressing a data chunk;

FIG. 12 is a flow diagram illustrating one embodiment of a method for generating cloud files; and

FIG. 13 illustrates a diagrammatic representation of a machine in the exemplary form of a computer system within which a set of instructions, for causing the machine to perform any one or more of the methodologies discussed herein, may be executed.

### DETAILED DESCRIPTION

In the following description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “mapping”, “maintaining”, “incrementing”, “determining”, “responding”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The present invention may be provided as a computer program product, or software, that may include a machine-readable medium having stored thereon instructions, which may be used to program a computer system (or other electronic devices) to perform a process according to the present invention. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical or other form of propagated signals (e.g., carrier waves, infrared signals, digital signals, etc.)), etc.

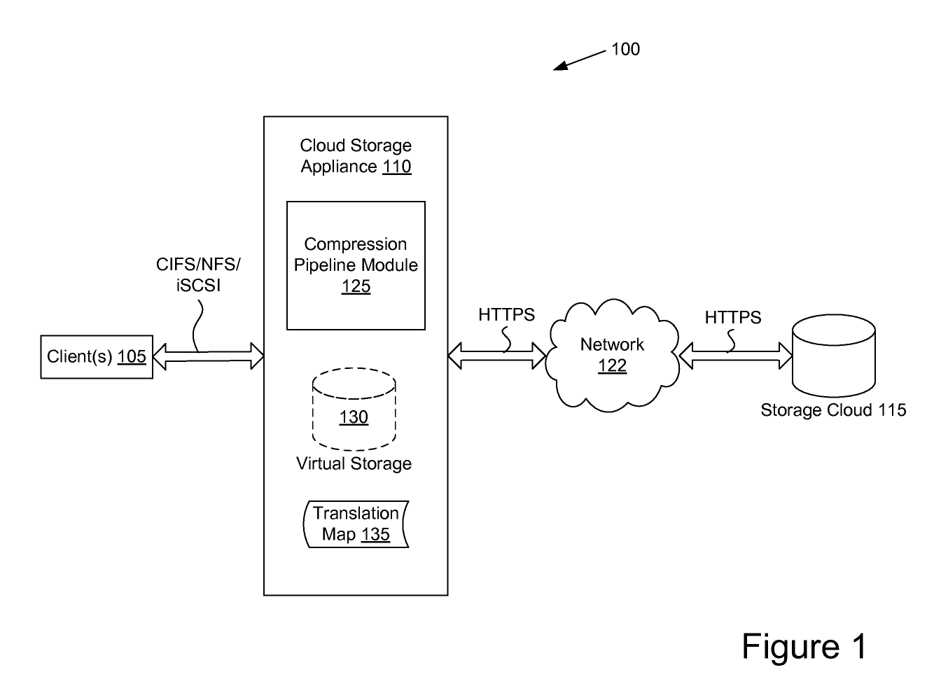

FIG. 1 illustrates an exemplary network architecture 100, in which embodiments of the present invention may operate. The network architecture 100 includes one or more clients 105 connected to a cloud storage appliance 110. The clients 105 may be connected to the cloud storage appliance 110 directly or via a local network (not shown). The network architecture 100 further includes the cloud storage appliance 110 connected to a storage cloud 115 via a network 122, which may be a public network, such as the Internet, a private network, such as a wide area network (WAN), or a combination thereof.

Storage cloud 115 is a dynamically scalable storage provided as a service over a public network (e.g., the Internet) or a private network (e.g., a wide area network (WAN). Some examples of storage clouds include Amazon's® Simple Storage Service (S3), Nirvanix® Storage Delivery Network (SDN), Windows® Live SkyDrive, Ironmountain's® storage cloud, Rackspace® Cloudfiles, AT&T® Synaptic Storage as a Service, Zetta® Enterprise Cloud Storage On Demand, IBM® Smart Business Storage Cloud, and Mosso® Cloud Files. Most storage clouds provide unlimited storage through a simple web services interface (e.g., using standard HTTP commands or SOAP commands). However, most storage clouds 115 are not capable of being interfaced using standard file system protocols such as common internet file system (CIFS), direct access file systems (DAFS), block-level network storage devices such as internet small computer systems interface (iSCSI) or network file system (NFS). The storage cloud 115 is an object based store. Data objects stored in the storage cloud 115 may have any size, ranging from a few bytes to the upper size limit allowed by the storage cloud (e.g., 5 GB).

In one embodiment, each of the clients 105 is a standard computing device that is configured to access and store data on network storage. Each client 105 includes a physical hardware platform on which an operating system runs. Examples of clients 105 include desktop computers, laptop computers, tablet computers, netbooks, mobile phones, etc. Different clients 105 may use the same or different operating systems. Examples of operating systems that may run on the clients 105 include various versions of Windows, Mac OS X, Linux, Unix, O/S 2, etc.

Cloud storage appliance 110 may be a computing device such as a desktop computer, rackmount server, etc. Cloud storage appliance 110 may also be a special purpose computing device that includes a processor, memory, storage, and other hardware components, and that is configured to present storage cloud 115 to clients 105 as though the storage cloud 115 was a standard network storage device. In one embodiment, cloud storage appliance 110 is a cluster of computing devices. Cloud storage appliance 110 may include an operating system, such as Windows, Mac OS X, Linux, Unix, O/S 2, etc. Cloud storage appliance 110 may further include a compression pipeline module 125, virtual storage 130 and translation map 135. In one embodiment, the cloud storage appliance 110 is a client that runs a software application including the compression pipeline module 125, virtual storage 130 and translation map 135.

In one embodiment, clients 105 connect to the cloud storage appliance 110 via standard file systems protocols, such as CIFS or NFS. The cloud storage appliance 110 communicates with the client 105 using CIFS commands, NFS commands, server message block (SMB) commands and/or other file system protocol commands that may be sent using, for example, the internet small computer system interface (iSCSI) or fiber channel. NFS and CIFS, for example, allow files to be shared transparently between machines (e.g., servers, desktops, laptops, etc.). Both are client/server applications that allow a client to view, store and update files on a remote storage as though the files were on the client's local storage.

The cloud storage appliance 110 communicates with the storage cloud 115 using cloud storage protocols such as hypertext transfer protocol (HTTP), hypertext transport protocol over secure socket layer (HTTPS), simple object access protocol (SOAP), representational state transfer (REST), etc. Thus, cloud storage appliance 110 may store data in storage cloud 115 using, for example, common HTTP POST or PUT commands, and may retrieve data using HTTP GET commands. Cloud storage appliance 110 formats each message so that it will be correctly interpreted and acted upon by storage cloud 115.

In a conventional network storage architecture, clients 105 would be connected directly to storage devices, or to a local network (not shown) that includes attached storage devices (and possibly a storage server that provides access to those storage devices). In contrast, the illustrated network architecture 100 does not include any network storage devices attached to a local network. Rather, in one embodiment of the present invention, the clients 105 store all data on the storage cloud 115 via cloud storage appliance 110 as though the storage cloud 115 was network storage of the conventional type.

The cloud storage appliance emulates a file system stack that is understood by the clients 105, which enables clients 105 to store data to the storage clouds 115 using standard file system semantics (e.g., CIFS or NFS). Therefore, the cloud storage appliance 110 can provide a functional equivalent to traditional file system servers, and thus eliminate any need for traditional file system servers. In one embodiment, the cloud storage appliance 110 provides a cloud storage optimized file system that sits between an existing file system stack of a conventional file system protocol (e.g., NFS or CIFS) and physical storage that includes the storage cloud 115.

In one embodiment, the cloud storage appliance 110 includes a virtual storage 130 that is accessible to the client 105 via the file system protocol commands (e.g., via NFS, CIFS or iSCSI commands). The virtual storage 130 is a storage system that may be, for example, a virtual file system or a virtual block device. The virtual storage 130 appears to the client 105 as an actual storage, and thus includes the names of data (e.g., file names or block names) that client 105 uses to identify the data. For example, if client 105 wants a file called newfile.doc, the client 105 requests newfile.doc from the virtual storage 130 using a CIFS, NFS or iSCSI read command. By presenting the virtual storage 130 to client 105 as though it were a physical storage, cloud storage appliance 110 may act as a storage proxy for client 105. In one embodiment, the virtual storage 130 is accessible to the client 105 via block-level commands (e.g., via iSCSI commands). In this embodiment, the virtual storage 130 is represented as a storage pool, which may include one or more volumes, each of which may include one or more logical units (LUNs).

In one embodiment, the cloud storage appliance 110 includes a translation map 135 that maps the names of the data (e.g., file names or block names) that are used by the client 105 into the names of data chunks that are stored in the storage clouds 115. The data chunks may each be identified by a permanent globally unique identifier. Therefore, the cloud storage appliance 110 can use the translation map 135 to retrieve data chunks from the storage clouds 115 in response to a request from client 105 for data included in a LUN, volume or pool of the virtual storage 130. Data chunks may be compressed data chunks. Data chunks are discussed in greater detail below.

The cloud storage appliance 110 may also include a local cache (not shown) that contains a subset of data stored in the storage cloud 115. The cache may include, for example, data that has recently been accessed by one or more clients 105 that are serviced by cloud storage appliance 110. The cache may also contain data that has not yet been written to the storage cloud 115. The cache may be a cache hierarchy that includes a memory cache and a disk cache. Upon receiving a request to access data, cloud storage appliance 110 can check the contents of the cache before requesting data from the storage cloud 115. That data that is already stored in the cache does not need to be obtained from the storage cloud 115.

In one embodiment, when a client 105 attempts to read data, the client 105 sends the cloud storage appliance 110 a name of the data (e.g., as represented in the virtual storage 130). The cloud storage appliance 110 determines the most current version of the data and a location or locations for the most current version in the storage cloud 115 (e.g., using the translation map 135). The cloud storage appliance 110 then obtains the data from the storage cloud 115.

Once the data is obtained, it may be decompressed and decrypted by the cloud storage appliance 110, and then provided to the client 105. Additionally, the data may have been subdivided into multiple data chunks that were compressed and written to the storage cloud 115. The cloud storage appliance 110 may combine the multiple data chunks to reconstruct the requested data. To the client 105, the data is accessed using a file system or block-level protocol (e.g., CIFS, NFS or iSCSI) as though it were uncompressed clear text data on local network storage. It should be noted, though, that the data may still be separately encrypted over the wire by the file system or block-level protocol that the client 105 used to access the data.

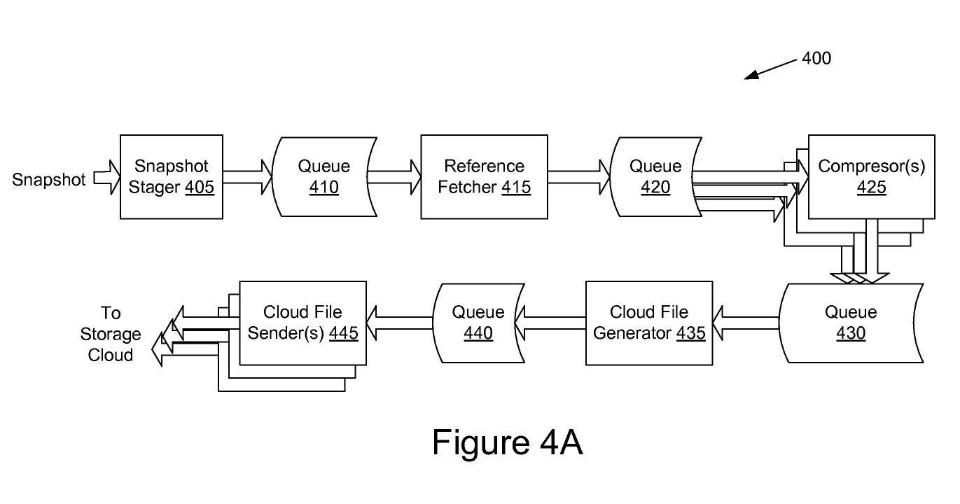

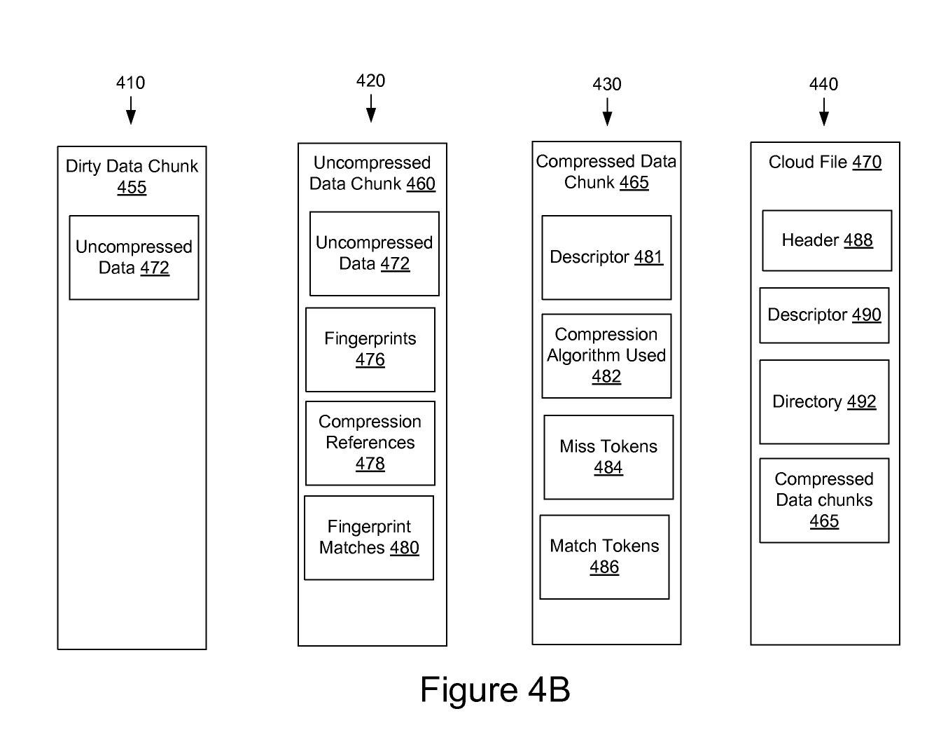

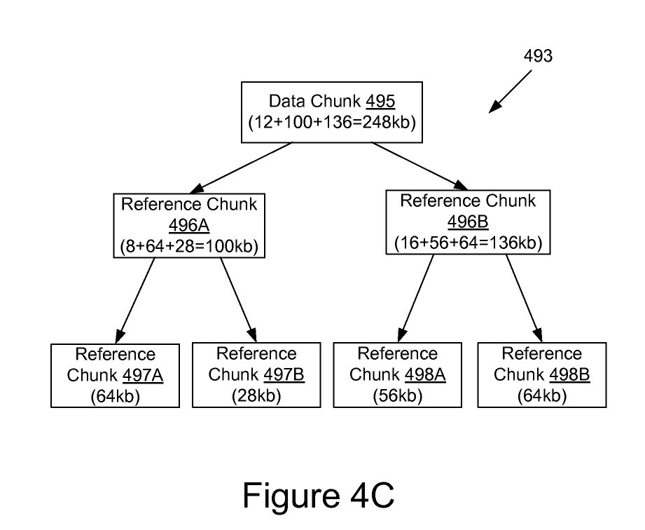

Similarly, when a client 105 attempts to store data, the data is first sent to the cloud storage appliance 110. A compression pipeline module 125 separates the data into data chunks, finds reference chunks (also referred to herein as target data chunks) to compress the data chunks against, compresses the data chunks (including performing deduplication and conventional compression), groups together compressed data chunks, and sends the groups of compressed data chunks to the storage cloud 115 using protocols understood by the storage cloud 115. In one embodiment, the compression pipeline module 125 performs these operations upon receiving a command to generate a snapshot of the virtual storage 130. The cloud storage appliance 110 may be configured to generate snapshots of the virtual storage 130 every 15 minutes, every half hour, hourly, daily, or on some other interval. Alternatively, operations for generating snapshots and storing data from snapshots are performed at different times. For example, snapshots may be generated every 10 minutes, but may only be compressed and written to the storage cloud 115 every hour. The compression pipeline module 125 is discussed in greater detail below with reference to FIG. 4A.

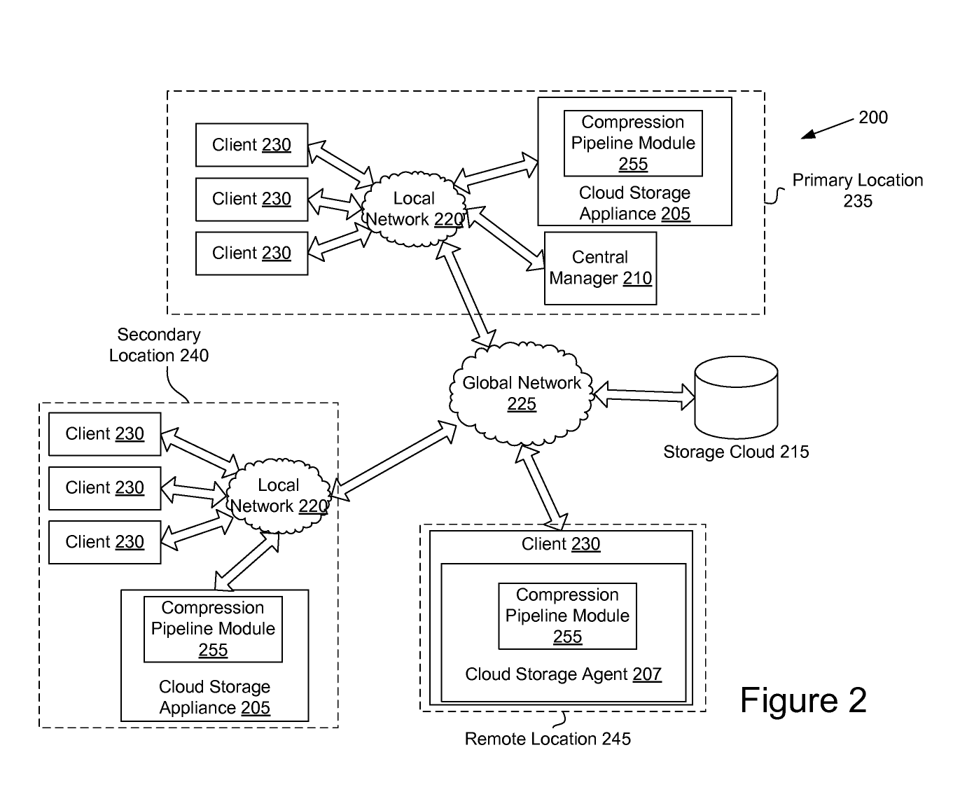

An enterprise may use multiple cloud storage appliances, and may include one or more cloud storage agents, all of which may be managed by a central manager to maintain data coherency. FIG. 2 illustrates an exemplary network architecture 200, in which multiple cloud storage appliances 205 and a cloud storage agent 207 are used at different locations (e.g., primary location 235, secondary location 240, remote location 245, etc.). Network architecture 200 further shows a storage cloud 215 connected with the cloud storage appliances 205 and cloud storage agent 207 via a global network 225. The global network 225 may be a public network, such as the Internet, a private network, such as a wide area network (WAN), or a combination thereof.

Each location in the network architecture 200 may be a distinct location of an enterprise. For example, the primary location 235 may be the headquarters of the enterprise, the secondary location 240 may be a branch office of the enterprise, and the remote location 245 may be the location of a traveling salesperson for the enterprise. Some locations include one or more clients 230 connected to a cloud storage appliance 205 via a local network 220. Other locations (e.g., remote location 245) may include only one or a few clients 230, one of which hosts a cloud storage agent 207. Additionally, in one embodiment, one location (e.g., the primary location 235) includes a central manager 210 connected to that location's local network 220. In another embodiment, the central manager 210 is provided as a service (e.g., by a distributor or manufacturer of the cloud storage appliances 205), and does not reside on a local network of an enterprise. Alternatively, one of the storage appliances may act as the central manager.

The cloud storage appliances 205, cloud storage agent 207 and central manager 210 operate in concert to provide the storage cloud 215 to the clients 230 to enable those clients 230 to store data to the storage cloud 215 using standard file system or block-level protocol semantics (e.g., CIFS, NFS, or iSCSI). Together, the cloud storage agent 207, cloud storage appliances 205 and central manager 210 emulate the existing file system stack or block-oriented storage that is understood by the clients 230. Therefore, the cloud storage appliances 205, cloud storage agent 207 and central manager 210 can together provide a functional equivalent to traditional file system or block-level storage servers, and thus eliminate any need for traditional file system or block-level storage servers. In one embodiment, the cloud storage appliance 205 and central manager 210 together provide a cloud storage optimized file system that sits between an existing stack of a conventional file system or block-level protocol (e.g., NFS, CIFS or iSCSI) and physical storage that includes the storage cloud and caches of the user agents.

Central manager 210 is responsible for ensuring coherency between different cloud storage appliances 205 and cloud storage agents 207. To achieve such coherency, the central manager 210 may manage data object names, manage the mapping between virtual storage and physical storage, manage file locks, manage encryption keys, and so on. The central manager 210 in one embodiment ensures synchronized access by multiple different cloud storage appliances and cloud storage agents to data stored within the storage cloud 215. Central manager 210 may also maintain data structures of the most current versions of all data chunks stored in the storage cloud 215. The cloud storage agent 207 and cloud storage appliances 205 may check with the central manager 210 to determine the most current version of data and a location or locations for the most current version in the storage cloud 215. The cloud storage agent 207 or cloud storage appliance 205 may then use the information returned by the central manager 210 to obtain the data from the storage cloud 215.

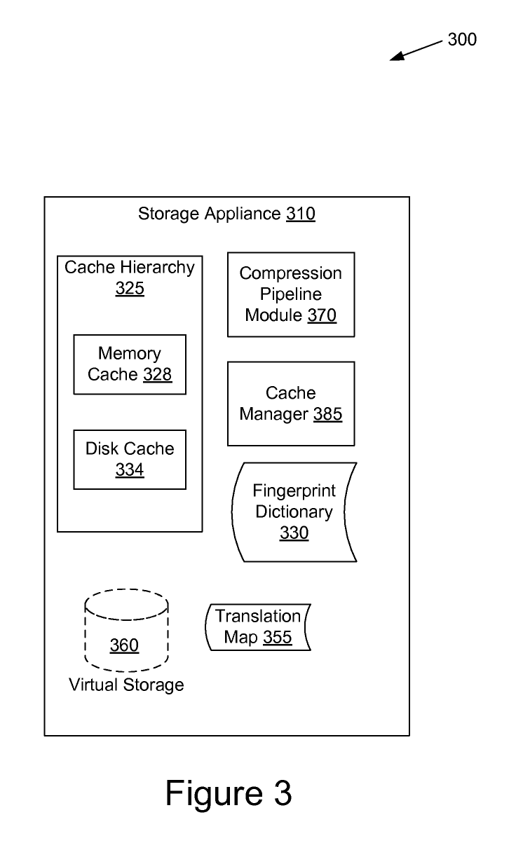

FIG. 3 illustrates a block diagram of a cloud storage appliance 310, in accordance with one embodiment of the present invention. Note that a cloud storage agent (e.g., such as cloud storage agent 207 of FIG. 2) may include the same or similar components to those described for the cloud storage appliance 310. In one embodiment, the cloud storage appliance 310 includes a cache hierarchy 325, a compression pipeline module 370, a virtual storage 360, a translation map 355, a cache manager 385 and a fingerprint dictionary 330. In one embodiment, the virtual storage 360 and translation map 355 operate as described above with reference to virtual storage 130 and translation map 135 of FIG. 1.

Referring to FIG. 3, the cache hierarchy 325 includes multiple levels of cache. In one embodiment, the cache hierarchy 325 includes a memory cache 328 and a disk cache 334. The memory cache 328 may be a volatile memory such as a random access memory (RAM). The disk cache may be a hard disk drive (or array of hard disk drives). In one embodiment, the cache hierarchy 325 further contains a flash cache (not shown). The flash cache may be a non-volatile memory such as a flash drive or solid state drive.

Each level of the cache hierarchy 325 includes a subset of data stored in the storage cloud. Each lower level in the cache hierarchy has a larger capacity, but more time is required to retrieve data from that cache level. The memory cache 328 may include, for example, data that has most recently been accessed by one or more clients, and disk cache 334 may include a larger amount of data that was less recently accessed. In one embodiment, the cache hierarchy 325 stores the data as clear text that has neither been compressed nor encrypted. This can increase the performance of the cache hierarchy 325 by mitigating any need to decompress or decrypt data in the cache hierarchy 325. In other embodiments, the cache hierarchy 325 stores compressed and/or encrypted data, thus increasing the cache's capacity and/or security.

Cache manager 385 manages data stored in the cache hierarchy 325. The cache hierarchy 325 often operates in a full or nearly full state. Once a level of the cache hierarchy 325 has filled up, cache manager 385 handles the removal of data from that level of the cache hierarchy 325 according to one or more cache maintenance policies, which can be applied at the volume and/or file level. These policies may be preconfigured, or chosen by an administrator. One policy that may be used, for example, is to remove the least recently used data from the cache hierarchy 325. Another policy that may be used is to remove data after it has resided in the cache hierarchy 325 for a predetermined amount of time. Other cache maintenance policies may also be used.

Compression pipeline module 370 compresses data and writes data to a storage cloud on the occurrence of predetermined events. Unless otherwise noted, the term compression as used herein incorporates deduplication and conventional compression. In one embodiment, compression pipeline module 370 compresses snapshots of the virtual storage 360 by separating the snapshot into data chunks and compressing the data chunks against reference chunks (data chunks already stored in the storage cloud, also referred to herein as target data chunks). Where a match is found between a portion of a data chunk and a portion of a reference chunk, the matching portion of the data chunk is replaced by a reference to the matching portion of the reference chunk to generate a compressed data chunk. The compressed data chunk may include a series of raw data strings (for unmatched portions of the data chunk) and references to stored reference chunks (for matched portions of the data chunk). Once this transformation is completed (i.e., the replacement of matched strings with references to those matched strings and the framing of the non-matched data), the resulting data can optionally be run through a conventional compression algorithm like ZIP, Lempel-Ziv-Markov chain algorithm (LZMA), Lempel-Ziv-Oberhumer (LZO), compress, etc.

In one embodiment, compression pipeline module 370 maintains a fingerprint dictionary 330. In one embodiment, the fingerprint dictionary 330 is a temporary dictionary. The fingerprint dictionary 330 is a table of fingerprints used for searching the cache hierarchy 325. Fingerprints are bit strings (e.g., fixed size bit strings) generated by a fingerprint function based on an input block of data. To generate a fingerprint, the input block of data (e.g., a 64 byte string) is input into the fingerprint function, and the fingerprint is output. The input and the output may be the same size (e.g., both may be 64 byte strings), or may have different sizes (e.g., a 64 byte string may be input and an 8 byte string may be output). Using a particular fingerprint function, the same fingerprint will always be generated from the same input block. Thus, matching fingerprints represent matching data. An example of a fingerprint function is a hash function (e.g., a cryptographic hash function such as message digest 5 (MD5)). Fingerprints generated by a hashing function are referred to as hashes.

The fingerprint dictionary 330 includes multiple entries, each entry including a fingerprint of data in the cache hierarchy 325 and a pointer to a location in the cache hierarchy 325 where the data associated with that fingerprint can be found. Therefore, in one embodiment, the compression pipeline module 370 generates multiple new fingerprints of regions of the data chunk, and compares those new fingerprints to fingerprint dictionary 330. When matches are found between the new fingerprints of the data chunk and fingerprints associated with a reference chunk, the cached reference chunk from which the fingerprint was generated can be compared to the portion of the data chunk from which the new fingerprint was generated, and strings of data from the data chunk that match strings of data from the reference chunk can be replaced with references to the reference chunk. The compression pipeline module 370 is discussed in greater detail below with reference to FIG. 4A.

FIG. 4A illustrates a block diagram of a compression pipeline 400, in accordance with one embodiment of the present invention. The compression pipeline 400 may be a data structure that is generated by a compression pipeline module such as compression pipeline modules 125, 255 and 370 of FIGS. 1, 2 and 3, respectively. The compression pipeline 400 receives an entire snapshot at one end, and outputs cloud files at the other end. In one embodiment, the compression pipeline 400 operates on a snapshot when the snapshot is generated. Alternatively, the compression pipeline 400 operates on a snapshot when a command to store the snapshot to the storage cloud is received. In another embodiment, the compression pipeline 400 operates on data continuously as the data changes. For example, upon a client writing a new file, the compression pipeline 400 may automatically compress data chunks associated with the new file and send them to the storage cloud.

In one embodiment, compression pipeline 400 includes a snapshot stager 405, a reference fetcher 415, a compressor 425, a cloud file generator 435 and a cloud file sender 445. Each of these components may be a separate stage in the compression pipeline 400. Moreover, each of the snapshot stager 405, reference fetcher 415, compressor 425, cloud file generator 435 and cloud file sender 445 may be separate threads. There may be multiple instances of some of the stages (each instance having a separate thread), such as the compressor 425 and the cloud file sender 445. These instances may operate in parallel, and draw data from and add data to the same queues.

Compression pipeline module 400 includes multiple queues 410, 420, 430, 440. Each of snapshot stager 405, reference fetcher 415, compressor 425 and cloud file generator 425 may place data into a specific queue after operating on the data. The next stage in the compression pipeline 400 may then pull a data chunk off the queue to operate on the data chunk. The stages in the compression pipeline 400 may append information to or remove information from data chunks that flow through the compression pipeline 400. For example, names of reference chunks, compression state, fingerprints, etc. may be added to the data chunks by various stages in the compression pipeline 400.

Snapshot stager 405 is the first stage in the compression pipeline 400. Snapshot stager 405 receives a snapshot (also known as a point-in-time copy) as input. A snapshot is a copy of the state of the virtual storage (or a portion of the virtual storage) as it existed at a particular point in time. The snapshot may be a snapshot of a pool, a volume within a pool, or an individual logical unit (LUN) of a volume. The snapshot may include the contents of payload data as it existed at the particular point in time, as well as contents of metadata such as a mapping between physical storage and virtual storage.

A snapshot may include multiple different layers. Each layer may be represented by one or more tables or other data structures. In one embodiment, snapshots include a payload layer and one or more metadata layers. The payload layer includes payload data, such as files, applications, folders, etc. The metadata layers include data that describe the payload data and/or other metadata. A first metadata layer may include information identifying names of payload data chunks, cloud files payload data chunks are contained in, offsets into cloud files where payload data chunks are located, sizes/lengths of payload data chunks, and so on. A second metadata layer may include information describing metadata data chunks from the first metadata layer. A third metadata layer may include information describing metadata data chunks from the second metadata layer, and so on.

Snapshot stager 405 may divide a snapshot into multiple data chunks. In one embodiment, the snapshot stager 405 separates the snapshot into a payload layer and one or more metadata layers, and separates that data from each of the layers into data chunks. For example, the snapshot stager 405 may divide the snapshot into a collection of payload data chunks and a collection of metadata data chunks. The size of the data chunks may be determined by the snapshot stager 405. In one embodiment, the data chunks have a size of approximately 64 kb. Alternatively, the data chunks may be 1 MB, 10 MB, 32 kb, or other larger or smaller sizes. The size of the data chunks may be independent from the block size of data blocks used by the file systems that interface with clients (e.g., by NTFS or CIFS). For example, a file system block size may be 4 kb, while the chunk size may be 64 kb or larger.

For a given snapshot, the snapshot stager 405 determines which of the data chunks have not yet been sent to the storage cloud, and thus still need to be sent to the storage cloud. Such data chunks are referred to as “dirty” data chunks. In one embodiment, a flag is set in dirty data chunks to identify them. The flag may be a single bit at a particular location of the data chunk. In one embodiment, the snapshot stager 405 examines data chunks one chunk at a time. The snapshot stager 405 may examine the data chunks sequentially, starting with the first data chunk in the snapshot and progressing to the last data chunk in the snapshot. The snapshot stager 405 places each data chunk that the snapshot stager 405 identifies as a dirty data chunk onto queue 410. Thus, the snapshot stager 405 populates the compression pipeline 400.

As described above, a snapshot may be divided into a payload layer and one or more metadata layers. In one embodiment, the snapshot stager 405 creates a write barrier between different layers of a snapshot. The snapshot stager 405 may first place all dirty payload data chunks from the payload layer onto the queue 410. Once all of the dirty payload data chunks from the payload layer are processed and sent to the storage cloud by the cloud file sender 445, the snapshot stager 405 begins placing dirty metadata data chunks from a first metadata layer into the queue 410. Once all of the dirty metadata data chunks from the first metadata layer are processed and sent to the storage cloud, snapshot stager 405 places dirty metadata data chunks from the second metadata layer onto queue 410. This process continues until all of the layers of the snapshot have been compressed and sent to the storage cloud. By creating the write barrier between layers of the snapshot, it can be guaranteed that data chunks from two separate layers (e.g., from the payload layer and from a metadata layer) will never be stored in the same cloud file.

The reference fetcher 415 is the second stage in the compression pipeline 400. The reference fetcher 415 pulls data chunks off of queue 410 in sequential order (starting from the first data chunk placed in the queue 410), and determines optimal reference chunks to use as compression references. A reference chunk is a compressed or uncompressed data chunk that has been previously stored in the storage cloud. In one embodiment, the reference fetcher 415 determines optimal reference chunks for a single data chunk at a time. The optimal reference chunks may be those target data chunks that will provide the highest compression. Alternatively, the optimal reference chunks may be those target data chunks that will provide high compression ratios and have a minimal retrieval load. The retrieval load, which is explained in greater detail below, is the total amount of bytes of data that will be retrieved from the storage cloud when a read on the reference chunk is requested. In another embodiment, the reference fetcher 415 pulls multiple data chunks off of queue 410, and determines the best reference chunks to use as compression references for a set of data chunks. In this case, the optimal reference chunks are those target data chunks that will provide the best combination of a high compression, require few input/output operations, and have a minimal retrieval load. The reference fetcher 415 may include multiple heuristics that can refine the determination as to which reference chunks are the optimal reference chunks.

Once the reference fetcher 415 has identified the optimal reference chunks to use as compression references for a data chunk or collection of data chunks, the reference fetcher retrieves these reference chunks. If a reference chunk is in a memory cache, then no retrieval operation is necessary. If the reference chunk is in the disk cache, then a copy of the reference chunk is retrieved from the disk cache and placed in the memory cache. Retrieving a reference chunk from the disk cache typically requires an input/output operation. If the reference chunk is not in the cache hierarchy, then the reference fetcher 415 retrieves the reference chunk from the storage cloud and places it in the memory cache (and possibly also in the disk cache). In one embodiment, reference fetcher 415 only fetches reference chunks from the cache hierarchy. In such an embodiment, reference chunks are not retrieved from the storage cloud for performing compression.

In one embodiment, the reference fetcher 415 places locks on all retrieved reference chunks that will be used as compression references. This ensures that those reference chunks will not be modified or deleted while the compression pipeline 400 compresses source data chunks against the target data chunks. The reference fetcher 415 may also place locks on the data chunks.

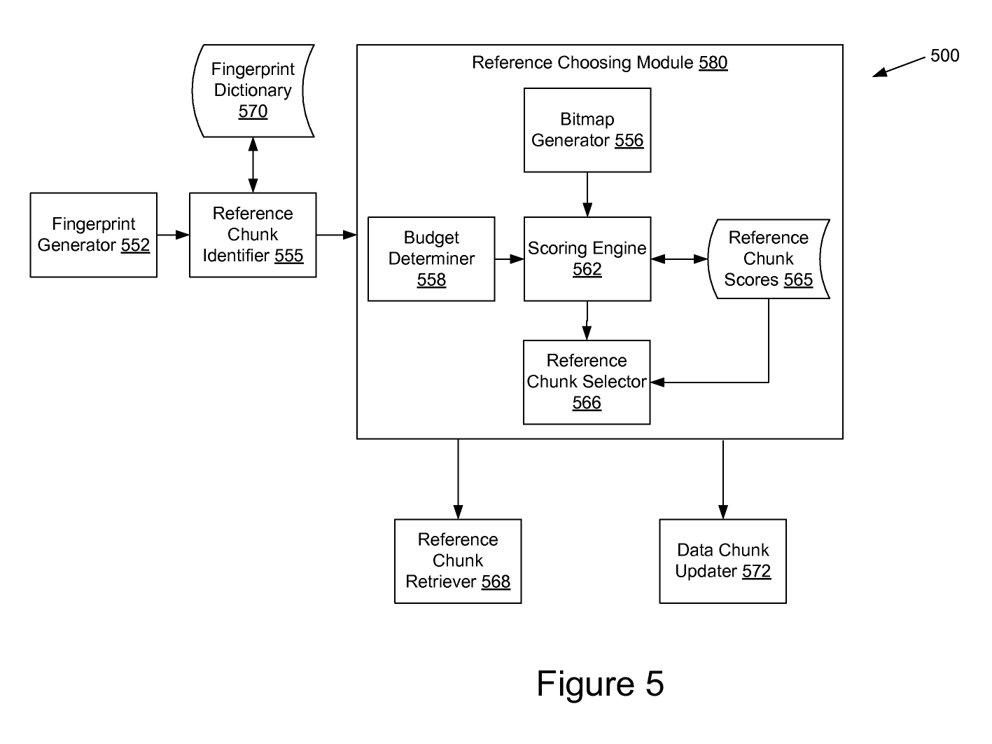

After reference fetcher 415 identifies optimal reference chunks for a data chunk and fetches them, reference fetcher 415 appends information to the data chunks. Such information may include names of reference chunks to use as compression references, fingerprints that were generated from the data chunk, and fingerprint matches between the data chunk and the reference chunks (including offset information into both the data chunk and the reference chunks). This information is used by compressor 425 to compress the data chunk against the identified reference chunks. The reference fetcher 415 is described in greater detail below with reference to FIG. 5.

Compressor 425 is the third stage in the compression pipeline 400, and operates on one data chunk at a time. The compressor 425 performs both deduplication and conventional compression (e.g., using gun zip (gzip), Basic Leucine Zipper 2 (bzip2), Lempel-Ziv-Markov chain algorithm (LZMA), or other compression algorithms). In one embodiment, multiple instances of compressor 425 may operate in parallel. Each instance may be a separate thread that compresses one data chunk at a time. As each compressor 425 compresses a data chunk, it places the compressed data chunk onto queue 430, pulls the next data chunk off of queue 420, then compresses that data chunk.

Data chunks that compressor 425 pulls off of queue 420 include information identifying reference chunks to compress the data chunk against, fingerprints that were generated from the data chunk, and offsets into the data chunk and/or reference chunks identifying the location of bytes that were used to generate the fingerprints. The information identifying the reference chunks to compress against may include those reference chunks' retrieval load values as well as the number of matching fingerprints for each of the reference chunks. Compressor 425 generates compressed data chunks using a reference compression scheme (known as deduplication). In such a compression scheme, compression is achieved by replacing portions of a data chunk with references to previous occurrences of the same data in one or more reference chunks. There are numerous searching techniques that may be used to compare portions of the data chunk to previously stored and/or compressed reference chunks. One such searching scheme is described herein, though other search schemes may also be used.

The compressor 425 matches the data chunk to the one or more reference chunks byte by byte. The match is performed by first matching bytes used to generate the fingerprints. Then the matches are extended in both directions until non-matching bytes are found. The compressor 425 replaces the matching portion of the data chunk with a reference to the reference chunk.

The compressed data chunk may include both raw data (for the unmatched portions) and references (for the matched portions). In an example, if the compressor 425 found matches for two portions of a data chunk, it would provide references for those two portions. The rest of the compressed data chunk would simply be the raw data. Therefore, an output might be 7 bytes of raw data, followed by a pointer to reference chunk 99 offset 5 for 66 bytes, followed by 127 bytes of clear data, followed by a pointer to reference chunk 1537 offset 47 for 900 bytes. In one embodiment, each match is encoded in a MATCH token, which contains the size of the match and the starting offsets in both the data chunk and reference chunks. In one embodiment, any data that does not match is encoded in a MISS token, which contains an offset and size followed by clear text data.

Once the data chunk has been compressed using the above described technique (e.g., deconstructed into a combination of MISS and MATCH tokens), it may be further compressed using a conventional compression algorithm (e.g., GZIP, LZMA or BZIP2, etc.). In one embodiment, the retrieval load value for the compressed data chunk is then determined. The retrieval load value represents the total amount of data (number of bytes of data) that will be retrieved from the storage cloud to read a data chunk. This includes the compressed size of the data chunk plus the sizes of any referenced data chunks, the sizes of additional reference data chunks that they reference, and so on. The retrieval load value is then compared to a retrieval load threshold. If the determined retrieval load value for the compressed data chunk exceeds the retrieval load threshold, the data chunk is recompressed using fewer reference chunks. The retrieval load value is again computed and compared to the retrieval load threshold. If the retrieval load threshold is still exceeded, the data chunk is merely compressed using a conventional compression algorithm and then placed into queue 430. If the retrieval load threshold is not exceeded, the compressed data chunk is then placed into queue 430. In one embodiment, a header is placed in the compressed data chunk identifying a compression algorithm that was used to compress the data chunk after performing the deduplication. Once compression is finished, locks that were placed on the reference chunks may be removed. The compression scheme used by compressor 425 is a lossless compression scheme. Therefore, compressed data chunks may be decompressed to reproduce the original data chunks exactly.

File systems such as NTFS and CIFS commonly introduce small blocks of data into file data and/or directory data. This causes minor differences between the same data in different versions of snapshots, which in turn introduces offsets into data chunks. Additionally, offsets may also be introduced by other mechanisms. Offsets of 2 kb, 4 kb, and 500 bytes and other sizes are common. As is discussed in greater detail below in regards to the reference fetcher, a data chunk is subdivided into multiple regions, and a representative fingerprint is generated for each region. A minor offset in a first region can cause the representative fingerprint for that region to change. Additionally, the offset can create a ripple that goes across the boundary of the region, and causes the representative fingerprint for the next region or multiple regions to also change. Changing the representative fingerprints causes a reduction in compression ratios. Therefore, when a snapshot is to be compressed using a deduplication technique, compression ratios may be reduced, even for regions where contents of the snapshots are unchanged (except for the offsets introduced by, for example, the file system). In one embodiment, the compressor 425 includes an offset mitigating heuristic that accounts for slight offsets such as those introduced by the NTFS and CIFS file systems.

As discussed above, compressor 425 begins matching at bytes that were used to generate the fingerprints. Compressor 425 then attempts to extend the match forward and backward to the bytes that were used to generate the next fingerprint (of the next region) or until the data is different. The compressor 425 merges all the matches that are sequentially arranged and contiguous into one match.

If there is a hole (no fingerprint matches) at either the region at the beginning of the data chunk or the region at the end of the data chunk, there is a probability that the data in this region matches the data in the reference chunk, even though the fingerprints failed to match. There is also a probability that there is a portion of the next (or previous) reference chunk that also matches the data chunk. Accordingly, in one embodiment, if either the first region or last region in a data chunk has a fingerprint that failed to match a fingerprint from the reference chunk, the compressor 425 retrieves the next reference chunk or the previous reference chunk. The compressor then attempts to continue matching bytes from the data chunk into the next or previous reference chunk. In one embodiment, the compressor 425 retrieves the next reference chunk (or previous reference chunk) if there is a contiguous alignment hole (absence of fingerprint matches) that extends to the first or last region. The contiguous alignment hole can have a size of up to (n−1)*(r), where n is the number of regions into which the data chunk has been divided and r is the region size. In other words, if the compressor 425 identifies a contiguous alignment hole at either end of the data chunk, then the next or previous reference chunk to the current reference chunk being matched against is blindly fetched and then compressed against. For example, a data chunk of 64 kb may have a region size of 8 kb (with a fingerprinting frequency of 1 fingerprint per 8 kb), and therefore has 8 regions that may be represented in an 8 bit or larger bitmap. A 1 in the bitmap represents a fingerprint match and a 0 represents no match. If the compressor fails to find a match in the first 0-8 kb (represented as 01111111 in an 8 bit bitmap), then the previous reference chunk is fetched and matched against. If the compressor fails to find a match for the last 48-64 kb (represented as 11111100 in an 8 bit bitmap), then the next reference chunk is fetched and matched against. Other examples of contiguous alignment holes that would cause the next or previous reference chunk to be fetched and compressed against include 00011111, 00000111, 11111110, 10000000, and so on. However, a non-contiguous hole such as 01001111 would not cause the next or previous reference chunk to be retrieved.

In one embodiment, the reference fetcher 415 does not fetch reference chunks for compressing metadata data chunks, and the compressor 425 does not perform deduplication on metadata data chunks. Instead, the reference fetcher 415 stage in the compression pipeline may be skipped for the metadata data chunks, and the compressor 425 may simply perform a conventional (e.g., a text based) compression on the metadata data chunks using a compression algorithm such as gzip, LZMA, or other compression algorithm. This may simplify and speed up future reads to the storage cloud.

The amount of time that it takes a compressor 425 to compress a data chunk is variable. For example, a compressor 425 may compress a first data chunk in 30 milliseconds, and a second data chunk in 100 milliseconds. As a result, compressed data chunks may be placed into queue 430 out of sequential order. This does not have any negative impact on data storage or retrieval.

Cloud file generator 435 pulls compressed data chunks off of queue 430, and groups the compressed data chunks into cloud files. Since the compressors 425 do not use a fixed time compression, compressed data chunks may be placed into the queue 430 (and thus pulled from queue 430) out of sequential order. Thus, compressed data chunks may be arranged into cloud files in any order.

In one embodiment, the cloud file generator 435 generates an empty cloud file container. The cloud file generator 435 than places compressed data chunks into the cloud file container until the cloud file reaches a threshold size or until a threshold number of compressed data chunks have been added to the cloud file, whichever happens first. Thus, in one embodiment, the cloud file size is limited by the number of data chunks as well as the total size of the cloud file.

The size threshold for the cloud files may be fixed or variable. The size threshold for the cloud files may be chosen based on how frequently its contents will be updated, cost per operation charged by cloud storage provider, etc. If cost per operation was free, the size of the data objects would be set very small. This would generate many I/O requests. Since storage cloud providers charge per I/O operation, very small data object sizes are therefore not desirable. Moreover, storage providers round the size of data objects up. For example, if 1 byte is stored, a client may be charged for a kilobyte. Therefore, there is an additional cost disadvantage to setting a data objects size that is smaller than the minimum object size used by the storage cloud.

There is also overhead time associated with setting the operations up for a read or a write. Typically, about the same amount of overhead time is required regardless of the size of the cloud files. If data chunks are placed into larger cloud files, then fewer read and fewer write operations are required to retrieve the same data from the storage cloud. Therefore, for small cloud files the setup cost dominates, and for large cloud files the setup cost is only a small fraction of the total cost spent obtaining the data. Based on these and other considerations, the cloud file size threshold is set. In one embodiment, the cloud file size threshold is 1 MB. However, other smaller or larger size thresholds may also be used, such as 500 KB, 5 MB, 15 MB, etc.

If compressed data chunks have high compression, many compressed data chunks may fit into the cloud file. However, when a cloud file is retrieved, the data chunks from the cloud file are decompressed, and the decompressed data is added to the cache hierarchy. If there are many compressed data chunks in a cloud file, then the contents of just a few cloud files may quickly fill up the cache. For example, if a cloud file contains 1024 compressed data chunks, the contents of the cloud file may decompress to 1 GB or more of data, which gets placed into the cache. Therefore, in order to keep the decompressed size of data chunks in a cloud file manageable, cloud files may be restricted to the maximum data chunk quantity threshold. The maximum data chunk quantity threshold may be 512 data chunks, 768 data chunks, 1024 data chunks, 2048 data chunks, or some other quantity of data chunks.

The cloud file generator 435 formats the cloud files using a cloud file format. In one embodiment, once the cloud file container is full, the cloud file generator 435 generates a directory that identifies where in the cloud file each compressed data chunk is located and the number of compressed data chunks in the cloud file. The cloud file generator 435 may also generate a header for the cloud file that identifies where in the cloud file the directory is located. The header may also indicate a size of the cloud file and a size of the directory. The cloud file generator 435 may also create a cloud descriptor for the cloud file. The cloud descriptor indicates which data chunks are referenced by data chunks stored in the cloud file. The cloud file generator 435 generates a unique identifier (e.g., a file number such as 000021) for the cloud file. The cloud file generator 435 then names the cloud file using the unique cloud file identifier. In one embodiment, the unique identifier includes a hash to randomize alphabetical ordering of information. In one embodiment, the cloud file generator 435 adds data to a descriptor of each data chunk contained in the cloud file. The cloud file generator 435 may add information identifying the cloud file that the data chunk is stored in and the location in the cloud file where the data chunk is stored. Once a cloud file is generated, filled and formatted, it is placed into queue 440.

Cloud file sender 445 is the fifth and final stage in the compression pipeline 400. For each cloud file, the cloud file sender 445 opens a socket connection to the storage cloud and sends the cloud file to the storage cloud. There may be multiple instances of the cloud file sender 445, each of which may be a separate thread. Each cloud file sender 445 may concurrently send cloud files to the storage cloud.

In one embodiment, when the storage cloud stores a cloud file, it writes a checksum (e.g., an MD5 checksum) to the cloud file. The storage cloud returns a successful storage response to the cloud sender 445 that includes the checksum. The cloud file sender 495 may add the checksum to a metadata structure that represents the cloud file. The metadata structure may include a file name, checksum, file size, etc. for the cloud file. In one embodiment, the metadata structure is a component of a first metadata layer of the snapshot.

After the cloud file sender 445 sends a cloud file to the storage cloud, the cloud file sender 445 inserts entries into the fingerprint dictionary 470 for fingerprints of some or all the data chunks that are in the cloud file. Once fingerprints for a data chunk are added to the fingerprint dictionary, that compressed data chunk can be used as a reference chunk for future data chunks.

As discussed earlier, in one embodiment, each data chunk references at most two reference chunks. Additionally, each of the reference chunks may themselves reference at most two other reference chunks, and so on. Therefore, the width of references (number of reference chunks a single data chunk can compress against) is limited to a maximum of 2 in one embodiment. FIG. 4C diagrammatically shows a reference tree 493 for a compressed data chunk 495 in which the width of references and depth of references are 2. Note that in other embodiments the width of references and/or the depth of references may be increased beyond 2. For example, the width of references may be set to 2 and the depth of references may be 4 or more.

In one embodiment, the depth of references is limited by the retrieval load value of the data chunk 495. Each reference chunk and data chunk may include its own retrieval load value. The retrieval load value for a reference chunk is equal to the size of the reference chunk plus the sizes of any additional reference chunks that it references. For example, reference chunks 497A and 498B each have a retrieval load value of 64 kb, reference chunk 497B has a retrieval load value of 28 kb and reference chunk 498A has a retrieval load value of 56 kb. Since none of reference chunks 497A, 497B, 498A or 498B reference any other reference chunks, their retrieval load values reflect the actual compressed size of these reference chunks. Reference chunk 496A references reference chunk 497A and reference chunk 497B. Therefore, reference chunk 496A has a retrieval load value of 100 kb, which includes the size of reference chunk 496A (8 kb) plus the retrieval load values of reference chunk 497A (64 kb) and reference chunk 497B (28 kb). Similarly, data chunk 495 has a retrieval load value of 248 kb, which includes the size of data chunk (12 kb) plus the retrieval load values of reference chunk 496A (100 kb) and reference chunk 496B (136 kb).

A retrieval load threshold may be set by the cloud storage appliance. The retrieval load threshold in one embodiment is set based on available network resources. The available network resources control the quantity of data that can be sent over the network in a given time period. For example, a T1 line has a line rate speed of 1.544 Mbits/s and a T3 line has a line rate speed of 44.376 Mbits/s. In one embodiment, the retrieval load threshold is set such that 128 data chunks can be retrieved from the storage cloud within 2 minutes. For example, a retrieval load threshold of 0.5 MB may be set for a T1 line, a retrieval load threshold of 1 MB may be set for a T3 line, etc. The retrieval load may be proportional or equal to a retrieval load budget, which is also determined based on the available network resources.

Once the retrieval load value for a data chunk reaches a retrieval load threshold, the data chunk cannot be referenced by any other data chunks. For example, if the retrieval load threshold was 248 kb, then data chunk 495 would not be referenced by any other data chunks.

Referring to FIG. 4A, each stage in the compression pipeline 400 may have a throttling mechanism for flow control. In one embodiment, each of the queues 410, 420, 430, 440 has a different maximum entry threshold. The stage that places data chunks into a particular queue will stop processing data chunks when the queue onto which it places data chunks fills up. For example, snapshot stager 405 will wait for the number of chunks at queue 410 to drop below a threshold value before it places more data chunks onto queue 410. Each queue may have a different threshold. In one embodiment, queue 410 has a threshold of about 100 data chunks, queue 420 has a threshold of about 200 data chunks and queue 430 has a threshold of about 1000 data chunks.

In one embodiment, the compression pipeline 400 may operate on multiple snapshots concurrently. In one embodiment, if multiple snapshots are to be compressed concurrently, a separate snapshot stager 405 instance is used for each snapshot. The separate snapshot stagers 405 may place data chunks into the same queue 410. Therefore, data chunks from different snapshots may be processed together, and placed into the same cloud files. Alternatively, an entire separate compression pipeline may be instantiated for each snapshot that is to be operated on. Thus, cloud files will only include data chunks from a single snapshot. In one embodiment, the multiple snapshots are from a single pool. Alternatively, snapshots from different pools may be operated on in parallel.

FIG. 4B illustrates one embodiment of the contents of queues in a compression pipeline. FIG. 4B illustrates the contents of queue 410, the contents of queue 420, the contents of queue 430, and the contents of queue 440, in accordance with one embodiment of the present invention. Queue 410 contains dirty data chunks 455, which include uncompressed data 472. Queue 420 contains uncompressed data chunks 460 with additional information that has been appended by a reference fetcher. The uncompressed data chunks 460 may include uncompressed data 472, fingerprints 476 that were generated from the uncompressed data 472, names of reference chunks to use as compression references 478 and fingerprint matches 480 between the reference chunks and the uncompressed data chunk 460.

Queue 430 contains compressed data chunks 465. The compressed data chunks 465 may include a collection of miss tokens 484 and match tokens 486, as well as an identification of a compression algorithm 482 used to compress the compressed data chunk 465. Note that the misses and matches may be represented other than by tokens. The tokens are just one example of a means to represent this information. In one embodiment, compressed data chunk 465 includes a descriptor 481. The descriptor may include information on the size of the compressed data chunk 465, as well as the retrieval load value for the compressed data chunk. Once the compressed data chunk is added to a cloud file, the descriptor may also be modified to include an identification of the cloud file it is in as well as its location in the cloud file.

Queue 440 contains cloud files 470. Each cloud file 470 may include compressed data chunks 465, a directory identifying where in the cloud file 470 each of the compressed data chunks 465 is located, a header 488 identifying where in the cloud file 470 the directory 492 is located, and a descriptor 490. The descriptor 490 identifies which data chunks are referenced by the data chunks included in the cloud file 470.

FIG. 5 illustrates one embodiment of a reference fetcher 500. The reference fetcher 500 may correspond to reference fetcher 415 of FIG. 4A. The reference fetcher 500 may include a fingerprint generator 552, a target data chunk identifier 555, a reference checking module 580, a reference chunk retriever 568 and a data chunk updater 572.

Fingerprint generator 552 generates fingerprints from a data chunk that is to be compressed. The fingerprint generator 552 divides a data chunk to be compressed into regions. In one embodiment, the boundaries on which the data chunk is divided are spaced as closely as can be afforded. The smaller the regions, the greater the compression achieved, but the slower compression becomes. The regions may be, for example, 4 kb regions, 8 kb regions, 16 kb regions, or regions having other sizes.

For each region, the fingerprint generator 552 computes multiple fingerprints (e.g., hashes) over a moving window of a predetermined size. In one embodiment, the moving window has a size of 32 or 64 bytes. In another embodiment, the generated fingerprint has a size of 32 or 64 bytes. It should be noted, though, that the size of the fingerprint input may be independent from the size of the fingerprint output.

Once the first fingerprint is generated, the subsequent fingerprints generated from the moving window are generated at a constant cost. For example, the first 64 bytes in a region may be used to prime the fingerprint. For every subsequent byte, fingerprint generator 552 may add the subsequent byte and remove the first byte. This can be done very efficiently using two XOR operations. Using this technique, given a previous fingerprint, the fingerprint generator 552 can generate the next fingerprint in constant time.

The fingerprint generator 552 selects a fingerprint for each region. The chosen fingerprint is used to represent the region to determine whether any portion of the region matches a region of a reference chunk. The chosen fingerprint is the fingerprint that would be easiest to find again. Examples of such fingerprints include those that are arithmetically the largest or smallest, those that represent the largest or smallest value, those that have the most 1 bits or 0 bits, etc. The size of the region represented by a fingerprint can range from the size of the fingerprint (e.g., 64 bytes) to the size of the data chunk (e.g., 64 kb). If the size of the region is the size of the fingerprint (e.g., 64 bytes), maximum possible compression will be achieved, but with a high resource utilization cost. On the other hand, if the size of the region is the size of the data chunk, there will be a low resource utilization cost, but compression levels will be low. In one embodiment, each region is ⅛ the size of the data chunk. Therefore, a data chunk of 64 kb will have 8 kb regions. In alternative embodiments, other region sizes may be used.

The reference chunk identifier 555 compares the chosen fingerprints to fingerprints stored in a fingerprint dictionary 570. The fingerprint dictionary 570 includes multiple entries, each entry including a fingerprint, and reference chunks associated with the fingerprint. The reference chunk included in an entry may be any data chunk that has been sent to the storage cloud. Alternatively, in one embodiment, only reference chunks belonging to the same layer as a current data chunk are included in entries of the fingerprint dictionary 570. In such an embodiment, there may be a separate fingerprint dictionary for each layer of a snapshot. The fingerprint dictionary 570 may include data for up to a threshold number of reference chunks for each fingerprint. The data for each reference chunk may include the name of the reference chunk, and an offset into the reference chunk identifying where the bytes used to generate the fingerprint reside. Additionally, the data for each reference chunk may include the retrieval load value for that reference chunk. The fingerprint dictionary 570 may have a width, where there are up to the width number of reference chunks associated with a particular fingerprint. The width of the fingerprint dictionary may be 8, 16, 32, 64, or some other value. The fingerprint dictionary 570 may also include in each entry an identification of which level of a cache hierarchy is presently storing the reference chunk.

There may be multiple fingerprint dictionaries, each of which is associated with a particular snapshot layer. For example, there may be a fingerprint dictionary for the payload layer, a separate fingerprint dictionary for the first metadata layer, a separate fingerprint dictionary for the second metadata layer, and so on. Thus, in one embodiment a single fingerprint dictionary does not include fingerprint data for multiple layers. Accordingly, payload data chunks may reference each other, and metadata data chunks from a particular metadata layer may reference each other. However, a payload data chunk does not reference a metadata data chunk, or vice versa. Nor do metadata data chunks reference metadata data chunks from other metadata layers.

In one embodiment, there are multiple fingerprint dictionaries that are arranged in a hierarchy for a particular snapshot layer. Each fingerprint dictionary contains fingerprints of reference chunks, but contains a different number of fingerprints per reference chunk. For example, a top fingerprint dictionary in the hierarchy may contain fingerprints for reference chunks that were generated in the last 1 hour, and may contain a fingerprint for each 1 kb region of those reference chunks (e.g., 64 1 kb regions of a 64 kb reference chunk). A second level fingerprint dictionary may contain fingerprints for reference chunks that were generated in the last day, and may contain a fingerprint for each 4 kb region of those reference chunks (e.g., 16 4 kb regions of a 64 kb reference chunk). A third level fingerprint dictionary may contain fingerprints for reference chunks that were generated in the last week, and may contain a fingerprint for each 8 kb region of those reference chunks (e.g., eight 8 kb regions of a 64 kb reference chunk). Each level in the fingerprint dictionary hierarchy is a tradeoff between an ability to find smaller matches and an amount of space in the cache occupied by each reference chunk. The reference chunk identifier 555 may first look for data chunks in the top fingerprint dictionary, then in the lower levels of fingerprint dictionaries.

Typically, the fingerprint dictionary 570 will include multiple entries for a single fingerprint. Therefore, reference chunk identifier 555 often identifies many reference chunks that are potential candidates to compress against. In one embodiment, the reference chunk identifier 555 generates a data structure (e.g., a list) that includes fingerprint match information. Each fingerprint match entry in the data structure may include the fingerprint, an identification of the reference chunk used to generate the fingerprint, and an offset into the reference chunk where the fingerprint was generated. Fingerprint matches may also include an identification of the data chunk and an offset into the data chunk where the fingerprint was generated. Additionally, fingerprint matches may include or be associated with the retrieval load values for the candidate reference chunks.

Reference choosing module 580 receives an input of fingerprint match information for one or more data chunks. Reference choosing module 580 uses this information to choose an optimal reference chunk or reference chunks (e.g., reference chunk pairs) to compress the data chunks against. The reference choosing module 580 in one embodiment selects the reference chunks that are optimal for a given data chunk as well as the next and previous data chunks. In one embodiment, the reference choosing module 580 attempts to determine which reference chunks use the minimum amount of input/output operations as well as which reference chunks will provide the best compression. In a further embodiment, the reference choosing module 580 also attempts to determine which reference chunks will use a minimum amount of bandwidth when fetched from cloud storage (e.g., which reference chunks have minimal retrieval load values).

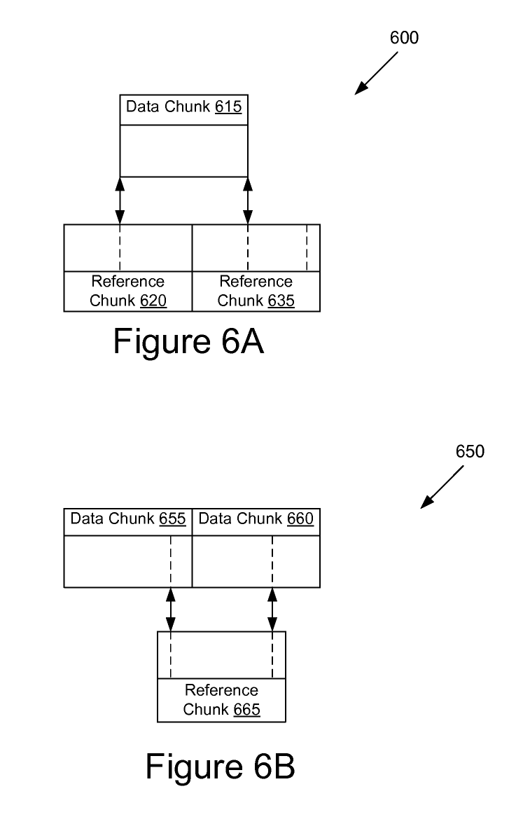

In one embodiment, the reference choosing module 580 chooses at most 2 reference chunks (a reference chunk pair) to compress each data chunk against. From the perspective of a block device, the primary case in which you get one block pointing to two different blocks that contain the same data is the offset case. Modifications that will create an offset (e.g., a deletion, insertion, replacement or transposition) will result in two reference chunks containing the data from a single data chunk. Therefore, the reference choosing module 580 will frequently choose two reference chunks to fully compress a data chunk against. An example of such an offset is shown in FIG. 6A, which illustrates an offset example 600 in which the contents of a data chunk 615 match portions of two sequential reference chunks (reference chunk 620 and reference chunk 635). Additionally, the same reference chunk will often be selected for two adjacent data chunks due to data movement between snapshots (e.g., insertions, deletions, replacements, transposition). An example of an offset that causes such a situation is shown in FIG. 6B. FIG. 6B illustrates another offset example 650, in which the contents of a reference chunk 665 match portions of two sequential data chunks (data chunk 655 and data chunk 660).

Returning to FIG. 5, in one embodiment, reference choosing module 580 includes a bitmap generator 556, a scoring engine 562 and a reference chunk selector 566. The reference choosing module 580 may also include a budget determiner 558. Bitmap generator 556 may generate a set of bitmaps for each data chunk that is to be compressed. For each bitmap set, bitmap generator 556 generates a separate reference chunk bitmap for each identified reference chunk. Each bitmap includes one or more bits for each region of the data chunk. For example, if the data chunk is a 64 kb data chunk that has been divided into 8 regions of 8 kb each, the bitmap may be an 8 bit bitmap.

The bitmap generator 556 processes the fingerprint match information that is received from reference chunk identifier 555. For each fingerprint match, the bitmap generator 558 sets a bit that represents a region in the data chunk (e.g., sets bit as a 1). The region is identified based on the offset information. For example, the first time a fingerprint associated with reference chunk 1 is encountered for data chunk 1, a bitmap for reference chunk 1 is generated. A bit that corresponds to the region of data chunk 1 associated with included data chunk offset information in the fingerprint match information is then set. When a new fingerprint match identifying reference chunk 1 and data chunk 1 is encountered, another bit is set for the region of data chunk 1 that is associated with offset information in the new fingerprint match information. Reference chunk bitmaps for a bitmap set are created, and bits set in those bitmaps, until all of the fingerprint match data for a particular data chunk has been processed. For each bitmap, a primary key is the data chunk and a secondary key is the match information. In one embodiment, each reference chunk bitmap is associated with a retrieval load value of the reference chunk represented by the reference chunk bitmap.

Once all bitmaps for reference chunks in a bitmap set are completed, bitmap generator 556 generates reference chunk pair bitmaps from the already generated bitmaps. In one embodiment, each reference chunk pair bitmap is a combination of two individual reference chunk bitmaps. Each reference chunk pair bitmap represents a reference chunk pair. Each combination may be generated by performing an OR operation between the two component bitmaps. For example, a first 8 bit bitmap for a first reference chunk may have the value 11110000, and a second 8 bit bitmap for a second reference chunk may have the value 00001111. The reference chunk pair bitmap from the first reference chunk and the second reference chunk would have the value 11111111, which indicates a high probability of perfect compression. In one embodiment, each reference chunk pair bitmap is also associated with a retrieval load value based on the sum of the retrieval load values of the two individual reference chunk bitmaps that it includes.

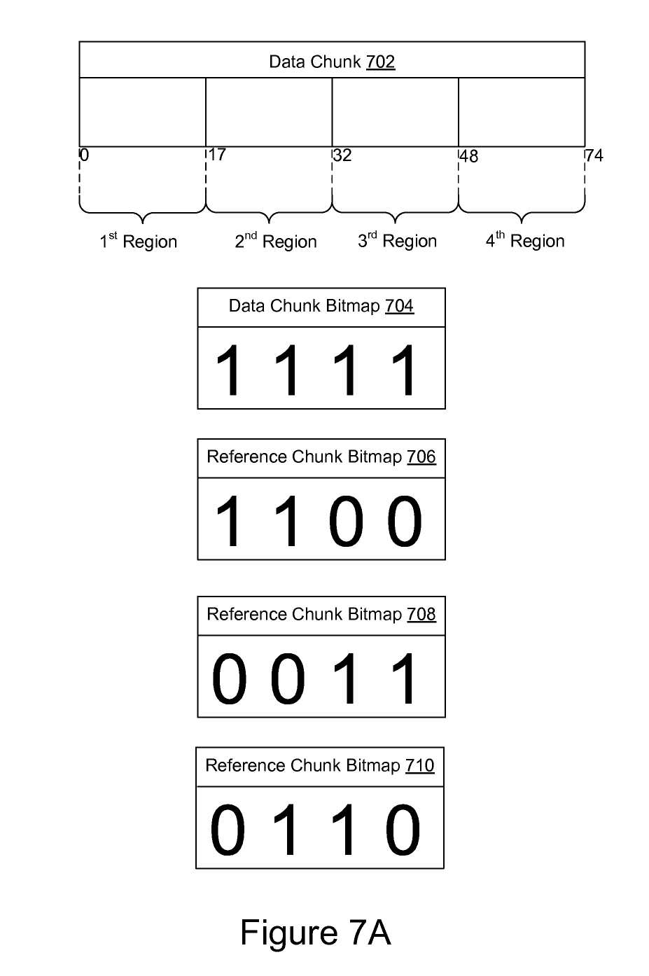

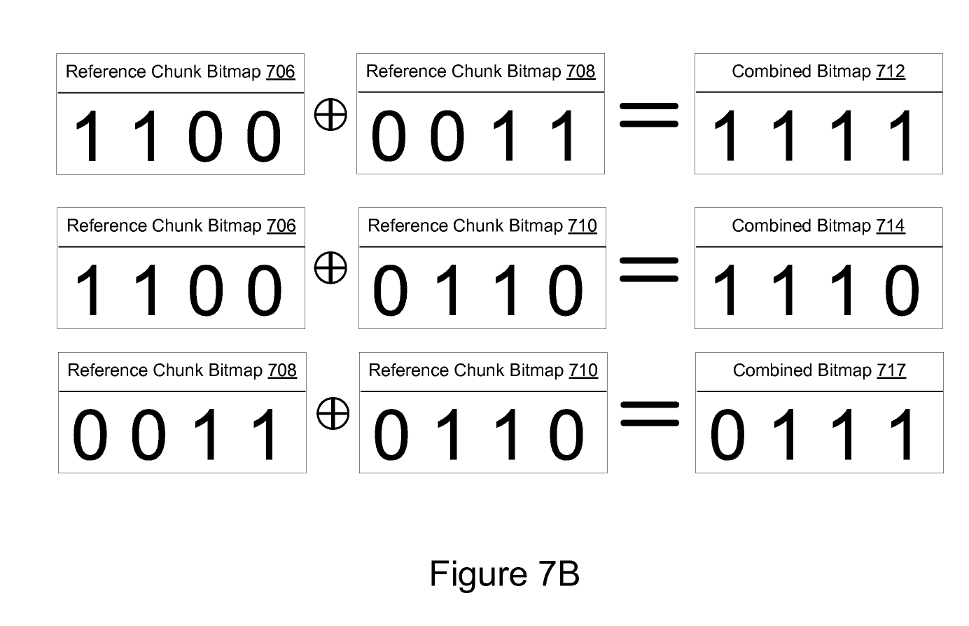

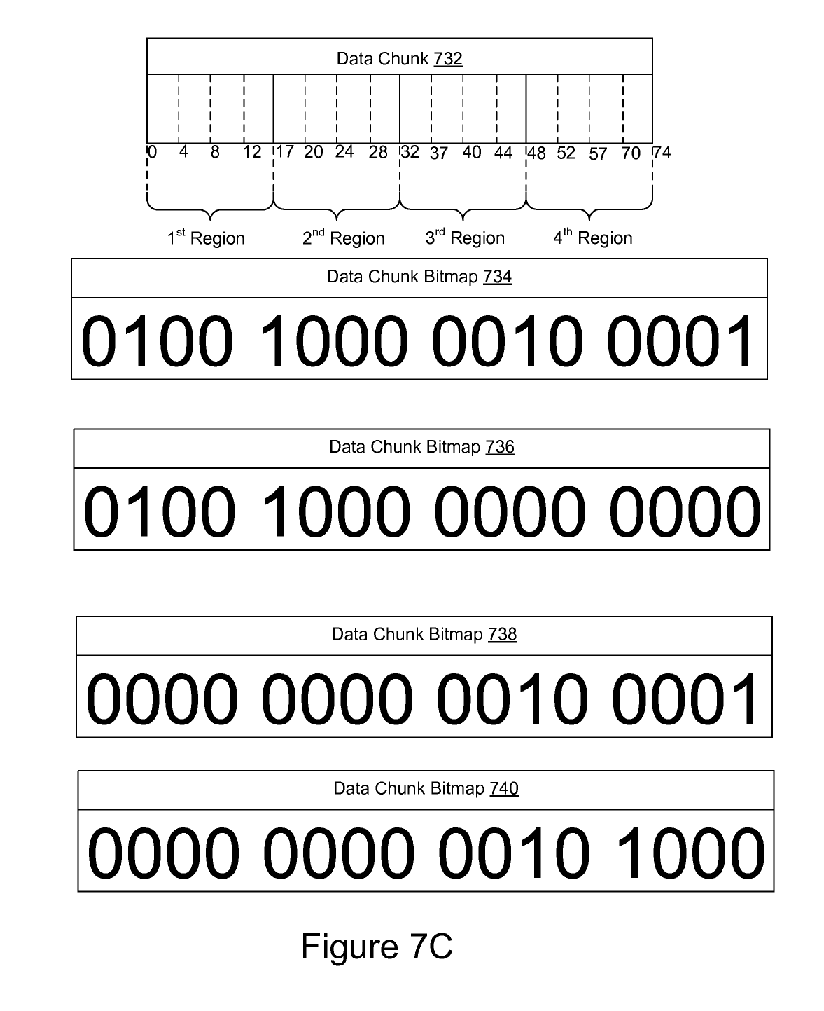

FIG. 7A is a block diagram showing an example data chunk 702 and example bitmaps, according to one embodiment of the present invention. In the illustrated example, the data chunk 702 is 64 kb in size, and is divided into four regions of 16 kb. Therefore, each reference chunk bitmap is a 4 bit bitmap. A data chunk bitmap 702 shows that the data chunk compresses perfectly against itself, as would be expected. Reference chunk bitmaps 706, 708, 710 each include one or more set bits that represent fingerprint matches to one or more of the data chunk's regions. For example, reference chunk bitmap 706 has a fingerprint match to the data chunk's 702 first region and second region.

FIG. 7B illustrates reference chunk pair bitmaps generated from reference chunk bitmaps 706, 708 and 710 of FIG. 7A. Reference chunk pair bitmap 712 is generated from reference chunk bitmap 706 and reference chunk bitmap 708. Reference chunk pair bitmap 714 is generated from reference chunk bitmap 706 and reference chunk bitmap 710. Reference chunk pair bitmap 716 is generated from reference chunk bitmap 708 and reference chunk bitmap 710. As shown, reference chunk pair bitmap 712 will have a higher compression ratio than either reference chunk pair bitmap 714 or reference chunk pair bitmap 716, because reference chunk pair bitmap 712 has more set bits (representing more fingerprint matches to data chunk 702).

Referring back to FIG. 5, once bitmap generator 556 completes a bitmap set for a data chunk (including generating the individual reference chunk bitmaps and the reference chunk pair bitmaps), it forwards the bitmap set on to scoring engine 562. Bitmap generator 556 then generates a bitmap set for the next data chunk. This process is continued until bitmap sets for all data chunks input into reference choosing module 580 are generated. Up to a threshold number of data chunks may be analyzed in parallel. In one embodiment, 128 data chunks are analyzed in parallel. Therefore, bitmap generator 556 may generate bitmap sets for up to 128 data chunks. The more data chunks that are processed in parallel, the higher a probability that optimal reference chunks will be chosen.

Scoring engine 562 scores each of the reference chunk pair bitmaps and individual bitmaps in a bitmap set based on the number of bits set in the bitmaps and/or the retrieval load values associated with the bitmaps. The number of set bits set in a bitmap provides a compression score for the bitmap and for the associated reference chunk or pair of reference chunks. For example, a reference chunk pair bitmap 11111111 would have a higher compression score than a reference chunk pair bitmap 11111110 or 01101111. Additionally, a retrieval load score can be computed from the bitmap's retrieval load value. The lower the retrieval load value, the fewer bytes that will later be fetched from the storage cloud to read that data chunk that is being compressed. In one embodiment, a lower retrieval load score is better. Alternatively, the retrieval load score may be computed based on an inverse of the retrieval load value, in which case a higher retrieval load score would be better. For the purposes of the following discussion, it is assumed that a lower retrieval load value is optimal.

In one embodiment, the scoring engine 562 weights the retrieval load score and the compression score. The scoring engine 562 then determines an aggregate score based on the weighted retrieval load score and weighted compression score. The reference chunk pair bitmaps and reference chunk bitmaps in the bitmap set may then be ordered based on their aggregate scores. For example, bitmaps in the bitmap set having a lower compression score may be given a higher rank if those bitmaps also have a lower retrieval load score. In one embodiment, only a threshold number of bitmaps are maintained for each bitmap set. For example, the 4, 8, 16, etc. bitmaps having the best aggregate scores in a bitmap set may be maintained, and other bitmaps in the bitmap set may be discarded.

In one embodiment, the scoring engine combines bitmaps between bitmap sets. The scoring engine 562 then determines a combined compression score, a combined retrieval load score, and a combined I/O utilization score for each combination of bitmaps (including reference chunk pair bitmaps and reference chunk bitmaps). In one embodiment, bitmaps from different bitmap sets of two data chunks are combined by performing an AND operation between the bitmaps. This combination of bitmaps can be used to determine a total compression score and total retrieval load score. Additionally, a combined I/O utilization score can be computed based on the reference chunks associated with the reference chunk pair bitmaps. The combined I/O utilization score identifies a total number of I/O operations that will be necessary to retrieve all of the reference chunks associated with a combination of bitmaps for compression. This may include I/O operations to the storage cloud and to the disk cache, or only I/O operations to the disk cache. The goal is to maximize the compression score and minimize the I/O utilization score. This should be contrasted with the retrieval load score, which identifies the total number of bytes that will be sent over the network when the reference chunks represented by the reference chunk pair bitmaps are read from the storage cloud. All possible combinations are performed, and each combination is scored. Based on the scoring of the different combinations, reference chunk scores 565 for each reference chunk and/or reference chunk pair are determined. These reference chunk scores include the compression scores, and may further include the I/O utilization scores and/or retrieval load scores.

There are multiple factors that affect whether an I/O operation will be necessary to obtain a reference chunk. First, if the reference chunk is in the memory cache, then no I/O operations are necessary to retrieve it. However, it typically costs a single I/O operation to retrieve each reference chunk from the disk cache. The disk cache and/or memory cache can be queried to determine whether a reference chunk is in the disk cache or memory cache. Alternatively, the fingerprint match information may identify a location of the reference chunk. In example, it may cost 4 I/O operations to retrieve 4 reference chunks from the disk cache and 3 I/O operations to retrieve 3 reference chunks from the disk cache. Accordingly, it is preferable to minimize the number of different reference chunks that need to be retrieved from the disk cache. This can be achieved by identifying reference chunks that have fingerprint matches to multiple data chunks. For example, if a reference chunk is common to two data chunks, then only a total of 3 I/Os may be required to retrieve all necessary reference chunks. However, if there is no common reference chunk between the two data chunks, 4 I/O operations may be required. Additionally, if the reference chunks are contiguous in address space on the disk cache, then a single seek operation may be used to retrieve all of the contiguous reference chunks from the disk cache. The seek operation is the most time and resource intensive portion of an I/O operation. Therefore, contiguous reference chunks in a disk cache are treated as zero I/O utilization cost. Each of these considerations affects the I/O utilization scores for combinations of reference chunk pairs.

I/O operations to retrieve reference chunks from the cloud storage may take considerably longer than I/O operations to retrieve reference chunks from the disk cache. Accordingly, in one embodiment, a single I/O operation to the storage cloud may be scored as the equivalent of multiple I/O operations to the disk cache. However, an I/O operation to the storage cloud may be performed in parallel to I/O operations to the disk cache. Therefore, the I/O utilization score in one embodiment is based on a non-trivial combination of storage cloud I/O operations and disk cache I/O operations. In one embodiment, each disk cache I/O operation is assigned a value of 1, and each storage cloud I/O operation is assigned a value based on the relative amount of time that it takes to complete a storage cloud I/O operation and the amount of time that it takes to complete a disk cache I/O operation. The amount of time that it takes to complete a disk cache I/O operation may depend, for example, on disk speeds of one or more disks in the disk cache and on a particular raid configuration of the disks. The amount of time that it takes to complete a storage cloud I/O operation may depend, for example, on a network bandwidth and/or latency to the storage cloud. In one embodiment, an amount of pending storage cloud I/O operations is used as a multiplier to the value assigned to a storage cloud I/O operation. The values of the disk cache I/O operations and of the storage cloud I/O operations that will be necessary to fetch reference chunks may be added to determine an I/O utilization score for a combination of references.

In one embodiment, each bitmap has a single bit per data chunk region. Therefore, if the data chunk is divided into 8 regions (with a single fingerprint per region), then the bitmap will have 8 bits. When a fingerprint match is represented in a bitmap, the information on the exact offset at which the fingerprint was generated is lost. This information is replaced with a byte range within which the fingerprint occurred. For example, for a 64 byte data chunk divided into 8 regions, a fingerprint with an offset of 0-8 kb will be associated with bit 1, a fingerprint with an offset of 8-16 kb would be associated with bit 2, etc.

To ameliorate the lost offset information, the number of bits in the bitmaps may be increased. The number of bits in the bitmap should be a multiple of the number of regions in a data chunk. For example, if 4 bits are used to represent each region in the data chunk, a 32 bit bitmap would be used for a data chunk that has 8 regions. If the data chunk was a 64 kb data chunk, then kilobytes 1-2 would be represented by bit 1, kilobytes 3-4 would be represented by bit 2, and so on. This can provide a fine grain distinction identifying where the fingerprint matches occurred. This enables the scoring engine 562 to better distinguish between two bitmaps that have similar scores. In one embodiment, the bitmap generator 556 has a parameter that defines how many bits to include per region.

FIG. 7C is a block diagram showing an example data chunk 732 and example bitmaps, according to one embodiment of the present invention. In the illustrated example, the data chunk 732 is 64 kb in size, and is divided into four regions of 16 kb. Each bitmap includes 4 bits per region, where the first bit represents the first 4 kb in a region, the second bit represents the next 4 kb in the region, and so on. Therefore, each bitmap is a 16 bit bitmap. A data chunk bitmap 734 shows the offset ranges from which fingerprints in each region were generated for the data chunk. Reference chunk bitmaps 736, 738, 740 each include one or more set bits that represent fingerprint matches to specific subsections of one or more of the data chunk's regions. If the bitmaps only included one bit per region, then reference chunk bitmap 738 and reference chunk bitmap 740 would be identical. However, because 4 bits are used per region, it can be determined that reference chunk bitmap 738 is a better match to data chunk bitmap 734 than is reference chunk bitmap 740. Therefore, reference chunk bitmap 738 is likely to provide better compression than reference chunk bitmap 740.

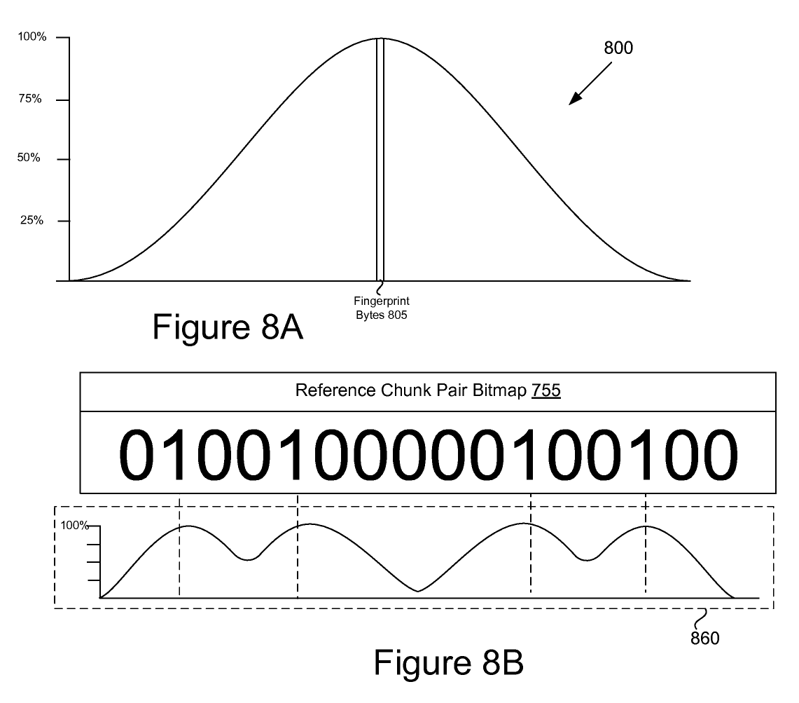

When bitmaps with multiple bits per region are used, additional heuristics may be applied to more accurately predict compression ratios. FIG. 8A illustrates a probability distribution 800 for matching between a data chunk and a reference chunk. The probability that the bytes 805 used to generate a fingerprint match is 100%. As the distance between a byte and the fingerprint bytes 805 increases, the lower the probability of a match. The match probability is data dependent. However, for the purpose of explanation, a Gaussian distribution will be used to illustrate the probability distribution. Note that in some instances other probability distribution models may be more appropriate, depending on the contents of the data that is being compressed.

When multiple bits per region are used, a bitmap can be converted into a probability distribution, as shown in FIG. 8B. FIG. 8B illustrates a probability distribution 860 generated from a reference chunk pair bitmap 855. The probability distribution may be generated by applying a Gaussian distribution (or other data dependent probability distribution) centered at each matching region. The resulting probability distribution map smoothes out the discrete 1s and 0s of the bitmap into a continuous (anti-aliased) probability distribution. The scoring engine 562 may then find an area under the curve to determine a total compression score for the reference chunk pair bitmap 855. If there is a match in a particular region “a”, then there is a non-zero probability that there is a match in surrounding regions “a+1”, “a−1”, “a+2” and “a−2.” There may also be non-zero probabilities that other surrounding regions will have matches. The probabilities of matches in any surrounding regions can be computed by applying probability distribution models. The more accurate a particular probability distribution model, the more accurate the predication on whether surrounding regions will have matches. Different probability distribution models may be generated for different types of data (e.g., one model for images, one model for electronic mail, one model for video, etc.).

Referring back to FIG. 5, in one embodiment, budget determiner 558 determines one or more resource budgets to use for the reference choosing module 580. Budget determiner 558 may determine resource budgets when reference choosing module 580 begins to operate on a set of received data chunks. Alternatively, budget determiner 558 may determine resource budgets separately for each data chunk as operations are performed for that data chunk. The resource budgets may include a processor budget (CPU budget) and an input/output (I/O) budget. The resource budgets may also includes a retrieval load budget. The retrieval load budget may be the same as the retrieval load threshold. Alternatively, the retrieval load budget may be a separate value that is proportional to the retrieval load threshold.

Increasing the CPU budget increases the amount of CPU resources that may be used to choose reference chunks. As the CPU budget increase, budget determiner 558 enables heuristics and increases a number of bits per region to use in bitmaps to increase the probability of choosing optimal reference chunks. For example, at a lowest CPU budget setting, bitmap generator 556 may be directed to generate bitmaps having 1 bit per region, and I/O utilization scores may not be computed. At a higher CPU budget, bitmap generator may be directed to use 2 bits per region, and I/O utilization scores may be computed. At a still higher CPU budget, bitmap generator 556 may generate bitmaps having 4 bits per region, and budget determiner 558 may enable an anti-aliasing heuristic (as described with reference to FIG. 8B).

As the I/O budget is increased, it becomes less important to minimize I/O operations. Thus, as the I/O budget increases, heuristics may be disabled. For example, if a high I/O budget is provided, then it may be unnecessary to compute I/O utilization scores. Accordingly, increasing the I/O budget may have an opposite effect to increasing the CPU budget.

Reference chunk selector 566 selects optimal reference chunks based on the reference chunk scores 565 (including compression scores, retrieval load scores and/or I/O utilization scores). Reference chunk selector 566 may select the references with the highest compression scores, the lowest I/O utilization scores and the lowest retrieval load scores for compression. In one embodiment, how reference chunk selector 566 weights these three scores is dependent on a ratio between the CPU budget, the retrieval load budget, and/or the I/O budget. For example, if the ratio between these budgets is 33/33/33, then the compression scores, retrieval load scores and I/O utilization scores may be equally weighted. However, if the ratio between the CPU budget, retrieval load budget and I/O budget is 50/25/25, then the compression score may be weighted more heavily than the retrieval load score and I/O utilization score, for example. In one embodiment, the retrieval load score is weighted more heavily than the compression score. In a further embodiment, the compression score is weighted more heavily than the I/O utilization score.

If both the I/O budget and the CPU budget are above threshold levels, then reference chunk selector 566 may select multiple reference chunk pairs for compression (e.g., the highest scoring two reference chunk pairs rather than just the highest reference chunk pair). The data chunk may be compressed against each of the reference chunk pairs. The compressed data chunk that experienced the best combination of compression retrieval load may then be kept, and the remaining compressed data chunk may be discarded. As the I/O budget and CPU budgets increase further, the data chunk may be further compressed against additional reference chunk pairs (or individual reference chunks). For example, the four highest scoring reference chunk pairs may be selected, and separate compressed data chunks may be generated by compressing the data chunk against each of the 4 reference chunk pairs.

In one embodiment, the budget determiner 558 determines a cloud budget in addition to determining an I/O budget and the CPU budget. When a cloud budget is used, reference chunks may be retrieved from the storage cloud for performing compression. The cloud budget may be set based on available network bandwidth to the storage cloud, latency between messages exchanged with the storage cloud, or other network properties. In one embodiment, the I/O utilization score is tied to both the I/O operations to the disk cache and the I/O operations to the storage cloud. A ratio between the I/O budget and the cloud budget may control how I/O operations to the storage cloud are weighted against I/O operations to the disk cache. For example, a single I/O operation to the storage cloud may be scored equivalently to two I/O operations to the disk cache.

Data chunk updater 572 appends information about the chosen reference chunks (e.g., the reference chunks' retrieval load scores, logical addresses, etc.), fingerprints and offsets to the data chunk. Reference chunk retriever 568 performs the necessary I/O operations to retrieve the selected reference chunks from the disk cache and/or storage cloud.

After reference chunk selector 566 has chosen references for the input data chunks, and the reference chunk retriever 568 has retrieved the reference chunks, reference choosing module 580 flushes reference chunk scores 565. In one embodiment, the reference chunk scores (e.g., compression scores and I/O utilization scores for reference bitmaps) for the last few (e.g., 1-3) data chunks are kept when the reference scores are flushed. These reference chunk scores may be used when determining the optimal reference chunks for the next set of data chunks. In one embodiment, maintaining the last few reference chunk scores from the previous set of data chunks provides a better I/O utilization score for the first few data chunks in the current run of data chunks that are processed.

In an alternative embodiment, a different reference choosing module (referred to herein as a prune tree) is used instead of the above described reference choosing module 580. Like the above described reference choosing module 580, the prune tree operates on one or more data chunks to identify the optimal reference chunks for those data chunks. In one embodiment, the prune tree operates on multiple data chunks in parallel.

For each data chunk that is to be compressed, the prune tree is populated with the received fingerprint match information. The fingerprint matches are arranged based on data chunk region. The reference chunk and offset information is arranged based on data chunk region. For example, as described above, a data chunk may be divided into 8 regions, each having a separate representative fingerprint. Those reference chunks including a fingerprint match for the first region may be placed into the prune tree first, with association to that first region. Those reference chunks including a fingerprint match for the second region may be placed into the prune tree next, with association to the second region, and so on. The prune tree is populated with this information for each data chunk to be considered, in sequential order.

Once the prune tree has been populated, the prune tree generates candidates from pairs of reference chunks in adjoining data chunk regions and/or adjoining data chunks. To begin, the prune tree generates candidates from the reference chunks of the first region and the second region of the first data chunk. If there were 16 reference chunks for each region, this would generate 256 candidates. The candidates are then scored, and those candidates with the highest scores are kept. In one embodiment, the 16 candidates with the highest scores are kept, and all other candidates are discarded. However, other quantities of candidates may also be kept.

In one embodiment, scoring is based on the number of data chunk regions whose fingerprints are matched by a candidate. For example, a candidate that matches the fingerprints of three regions of a data chunk is scored higher than a candidate that matches the fingerprints of just two regions. Scoring may also be based on similarity in offset information between the candidate and the data chunks. For example, between two candidates with the same number of matching regions, the candidate having offset information that is close to the offset information of the data chunk would score higher than the candidate having offset information that is not close.

After candidates are generated, and lower scoring candidates are discarded, the prune tree then combines the reference chunks from the next region to the candidates. If 16 candidates were kept, and the next region has 16 reference chunks, this generates another 256 possible combinations. If the candidate only includes a single reference chunk to begin with, then the new reference chunk is added to that single reference chunk. If the candidate includes two reference chunks, and one of those reference chunks is the same as the new reference chunk, then the candidate is unchanged (except that a score for the candidate increases). If the candidate includes two reference chunks, and the new reference chunk fails to match one of the two reference chunks, then there are three combination possibilities. The prune tree determines what the score for the candidate would be if the first existing reference chunk was replaced, if the second existing reference chunk was replaced, and if neither of the reference chunks were replaced (the new reference chunk is not used). The candidate is then updated to include the combination possibility that yields the highest score. Again, the highest scoring candidates are kept, and the remaining candidates are discarded. This process is then repeated again for the next data chunk region, until the top candidates for the entire first data chunk are determined.

After the top candidates for the first data chunk are determined, the prune tree begins identifying the top candidates for the second data chunk. To begin, the prune tree combines the top candidates from the first data chunk with the reference chunks for the first region of the next data chunk. The combination is performed as described above. The top candidates are then kept, and combined with the reference chunks for the next region of the second data chunk. This process is continued until the candidates have been combined with the reference chunks from all of the regions of the second data chunk. The top candidates for the second data chunk are then identified.

While the top candidates for the second data chunk are determined, the scoring for the candidates of the first data chunk may change. This change in scoring reflects updated data on the amount of I/O operations that would be required to retrieve the reference chunks of candidates for the second data chunk and candidates for the first data chunk.

The above process is repeated until candidates are generated for all of the data chunks. Based on the final scoring of the candidates for all of the data chunks that are being processed in parallel, optimal candidates are chosen. Each optimal candidate includes one or two optimal reference chunks to use to compress a data chunk against.

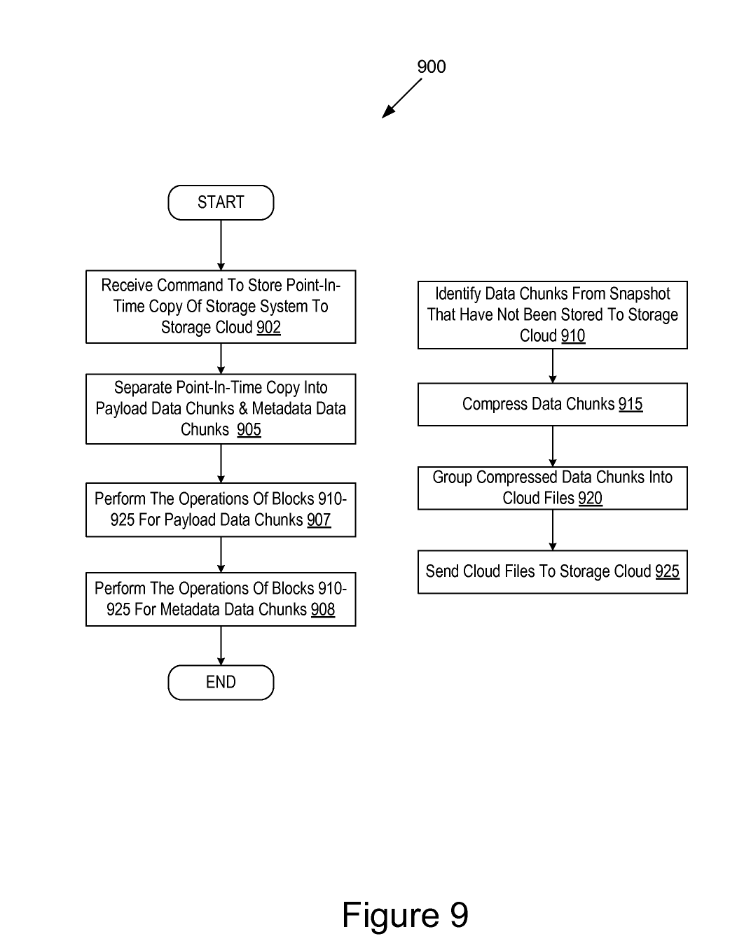

FIG. 9 is a flow diagram illustrating one embodiment of a method 900 for converting a snapshot (or point-in-time copy) into compressed data chunks. Method 900 may be performed by processing logic that may comprise hardware (e.g., circuitry, dedicated logic, programmable logic, microcode, etc.), software (e.g., instructions run on a processing device to perform hardware simulation), or a combination thereof. In one embodiment, method 900 is performed by a cloud storage appliance (e.g., cloud storage appliance 110 of FIG. 1). Alternatively, method 900 may be performed by a cloud storage agent. Method 900 may be performed, for example, by a compression pipeline running on a cloud storage appliance or cloud storage agent. For convenience, method 900 will be discussed with reference to a cloud storage appliance. However, it should be understood that method 900 may also be performed by other software and/or hardware elements.

Referring to FIG. 9, at block 902 of method 900 a cloud storage appliance receives a command to store a point-in-time copy of a storage system to a storage cloud. The point-in-time copy may be a snapshot of the storage system. In one example, the storage system is a physical storage system, such as an array of disk drives. Alternatively, the storage system may be a virtual block device, a virtual file system or some other storage system. The command may be received based on a timer. For example, commands to store snapshots to the storage cloud may be received every 10 minutes. In one embodiment, the command is received upon generation of the point-in-time copy.

At block 905, the cloud storage appliance separates the point-in-time copy into payload data chunks and metadata data chunks. The cloud storage appliance may further separate the metadata data chunks into first layer metadata data chunks, second layer metadata data chunks, third layer metadata data chunks, and so on up to a highest metadata layer. The first layer metadata data chunks include metadata describing the payload data chunks. The second layer metadata data chunks include metadata describing the first layer metadata data chunks, and so on.

At block 907, the cloud storage appliance performs operations to compress payload data chunks and send them to a storage cloud. This may include performing the operations of blocks 910, 915, 920 and 925 for payload data chunks.

At block 910, the cloud storage appliance identifies data chunks from the snapshot that have not been stored to a storage cloud (dirty data chunks). At block 915, the cloud storage appliance compresses the dirty data chunks. To compress the dirty data chunks, the cloud storage appliance may identify reference chunks to compress the dirty data chunks against, retrieve those reference chunks, and replace portions of the data chunks with references to matching portions of the reference chunks. Note that in one embodiment payload data chunks are only compressed against other payload data chunks that have already been stored to the storage cloud. Additionally, in one embodiment metadata data chunks from a particular metadata layer are only compressed against other metadata data chunks from that metadata layer that have already been stored to the storage cloud. Alternatively, payload data chunks and/or metadata data chunks may be compressed against any data chunks that have been sent to the storage cloud, regardless of that data chunk's layer. In one embodiment, metadata data chunks are not compressed against any reference chunks. Compressing dirty data chunks also includes performing a conventional compression using a compression algorithm such as gzip, LZMA, etc. on the data chunk after deduplication.

At block 920, the cloud storage appliance groups the compressed data chunks into cloud files. This may include generating an empty cloud file container, and adding compressed data chunks to the cloud file container until it fills up. In one embodiment, compressed data chunks are added to the cloud file until it reaches a size threshold. In another embodiment, compressed data chunks are added to the cloud file until a threshold number of compressed data chunks have been added. In still another embodiment, compressed data chunks are added to the cloud file until one of these two conditions is satisfied. At block 925, the cloud storage appliance then sends the cloud files to the storage cloud.

At block 908, the cloud storage appliance performs operations to compress metadata data chunks and send them to a storage cloud. This includes performing the operations of blocks 910, 915, 920 and 925 for metadata data chunks. In one embodiment, block 908 is repeated for each metadata layer. That is, blocks 910-925 are first performed for a first metadata layer. In one embodiment, for metadata data chunks, at block 915 only a conventional (e.g., text base) compression scheme such as gzip, LZMA, etc. is used. In other words, deduplication may not be performed for metadata data chunks. Once all of the metadata data blocks from the first metadata layer have been sent to the storage cloud, the cloud storage appliance performs blocks 910-925 for a second metadata layer. This process is repeated until metadata data chunks from all of the metadata layer have been processed. The method then ends.

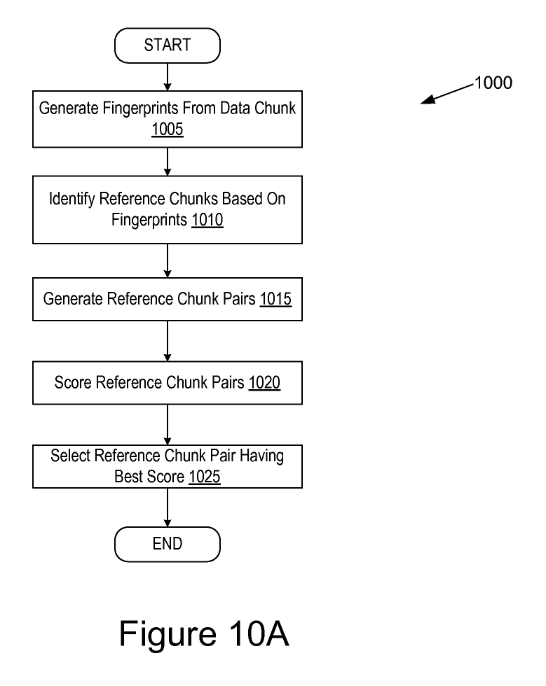

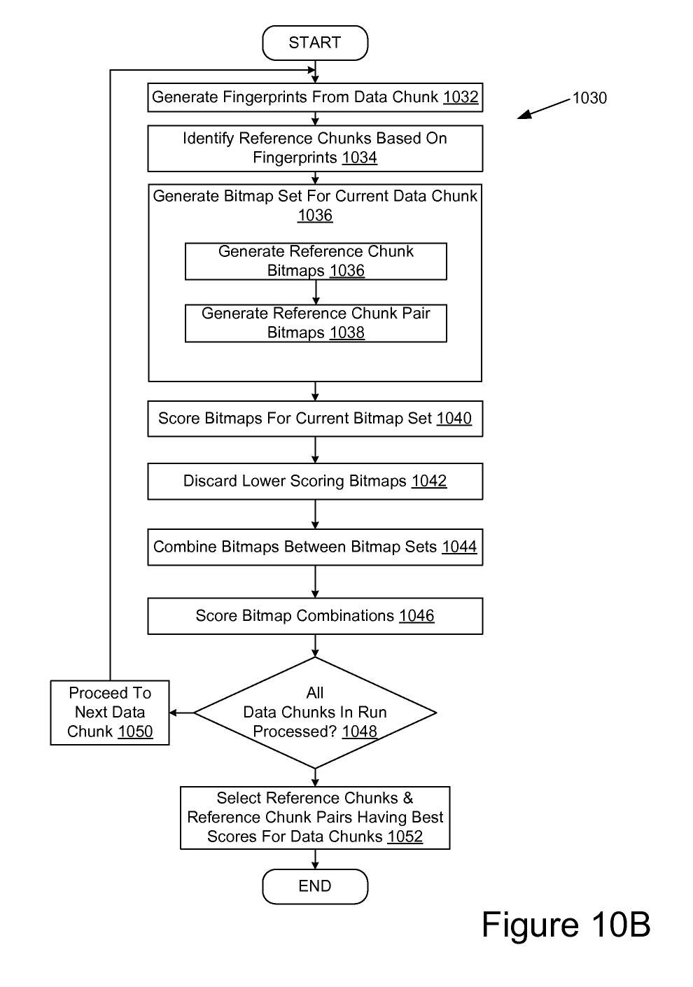

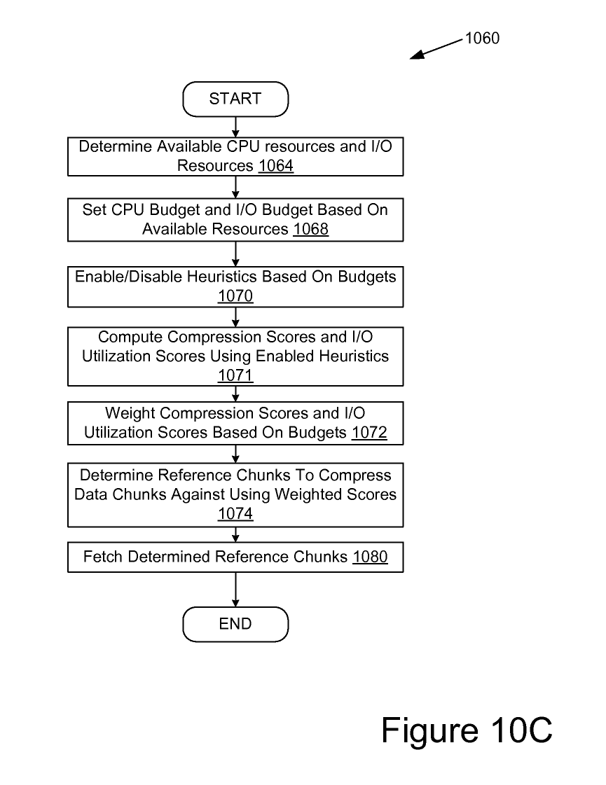

FIG. 10A is a flow diagram illustrating one embodiment of a method 1000 for selecting optimal reference chunks to use for compressing a data chunk. Method 1000 may be performed by processing logic that may comprise hardware (e.g., circuitry, dedicated logic, programmable logic, microcode, etc.), software (e.g., instructions run on a processing device to perform hardware simulation), or a combination thereof. In one embodiment, method 1000 is performed by a cloud storage appliance (e.g., cloud storage appliance 110 of FIG. 1). Alternatively, method 1000 may be performed by a cloud storage agent. Method 1000 may be performed, for example, by a reference choosing module running on a cloud storage appliance or cloud storage agent. For convenience, method 1000 will be discussed with reference to a cloud storage appliance. However, it should be understood that method 1000 may also be performed by other software and/or hardware elements.

Referring to FIG. 10A, at block 1005 of method 1000 a cloud storage appliance generates fingerprints from a data chunk. The cloud storage appliance may divide the data chunk into multiple regions. The cloud storage appliance may then generate multiple fingerprints, and select a representative fingerprint for each region.

At block 1010, the cloud storage appliance identifies multiple reference chunks based on the fingerprints. In one embodiment, the cloud storage appliance searches a fingerprint dictionary for each of the representative fingerprints. The fingerprint dictionary may identify reference chunks that are associated with the representative fingerprints, as well as retrieval load scores for these reference chunks.

At block 1015, the cloud storage appliance generates reference chunk pairs. Each reference chunk pair is a combination of two identified reference chunks. The reference chunk pairs may be represented as compression candidates, as reference chunk pair bitmaps, or as other data structures. At block 1020, the cloud storage appliance scores each of the reference chunk pairs. In one embodiment the reference chunk pairs are scored based on predicted compression ratios. The compression ratio for a reference chunk pair may be predicted based on the number of representative fingerprints of the data chunk that match fingerprints associated with the reference chunk pair. The reference chunk pairs may also be scored based on a number of I/O operations that will be required to retrieve the reference chunks in the reference chunk pair. Additionally, the reference chunk pairs may be scored based on the number of bytes of data that will be retrieved from the storage cloud to reconstruct the reference chunk (retrieval load values).

At block 1025, the cloud storage appliance selects the reference chunk pair having the best score (e.g., the highest compression score, the lowest retrieval load score and the lowest I/O utilization score). This reference chunk pair may then be used to compress the data chunk.

FIG. 10B is a flow diagram illustrating another embodiment of a method 1030 for selecting optimal reference chunks to use for compressing multiple data chunks. Method 1030 may be performed by processing logic that may comprise hardware (e.g., circuitry, dedicated logic, programmable logic, microcode, etc.), software (e.g., instructions run on a processing device to perform hardware simulation), or a combination thereof. In one embodiment, method 1030 is performed by a cloud storage appliance (e.g., cloud storage appliance 110 of FIG. 1). Alternatively, method 1030 may be performed by a cloud storage agent. Method 1030 may be performed, for example, by a reference choosing module running on a cloud storage appliance or cloud storage agent. For convenience, method 1030 will be discussed with reference to a cloud storage appliance. However, it should be understood that method 1030 may also be performed by other software and/or hardware elements.

Referring to FIG. 10B, at block 1032 of method 1030 a cloud storage appliance generates fingerprints from a data chunk. The cloud storage appliance may divide the data chunk into multiple regions. The cloud storage appliance may then generate multiple fingerprints, and select a representative fingerprint for each region.

At block 1034, the cloud storage appliance identifies multiple reference chunks based on the fingerprints. In one embodiment, the cloud storage appliance searches a fingerprint dictionary for each of the representative fingerprints. The fingerprint dictionary may identify reference chunks that are associated with the representative fingerprints as well as the reference chunks' retrieval load values.

At block 1036, the cloud storage appliance generates a bitmap set for the current data chunk. Generating the bitmap set may include generating reference chunk bitmaps (block 1036). The cloud storage appliance may generate a separate reference chunk bitmap for each identified reference chunk. For each reference chunk bitmap, the cloud storage appliance sets bits that correspond to regions of the data chunk having representative fingerprints that match fingerprints associated with the reference chunk. A retrieval load value may be associated with each reference chunk bitmap. Generating the bitmap set may further include generating reference chunk pair bitmaps (block 1038). Each reference chunk pair bitmap is a combination of two reference chunk bitmaps. The reference chunk bitmaps may be combined by performing an XOR operation, and/or adding the retrieval load values of the individual reference chunk bitmaps.

At block 1040, the cloud storage appliance scores bitmaps for the current data chunk. This includes scoring reference chunk bitmaps (representing a single reference chunk) and reference chunk pair bitmaps (representing pairs of reference chunks). The bitmaps may be scored by computing a compression score for each reference chunk bitmap. The bitmaps may also be scored by computing an I/O utilization score for each bitmap, and/or computing a retrieval load value for each bitmap.

At block 1042, the cloud storage appliance discards all but the best scoring bitmaps. The best scoring bitmaps may be those reference chunk bitmaps and/or reference chunk pair bitmaps having the highest compression scores, the retrieval load scores and/or the lowest I/O utilization scores. For example, the best scoring 16 reference chunk pair bitmaps may be kept. This may be predicated by ordering the bitmaps based on compression scores, retrieval load scores and/or I/O utilization scores.

At block 1044, the cloud storage appliance combines bitmaps between bitmap sets. This may include forming all possible combinations of all of the kept bitmaps from the current bitmap set with all of the kept bitmaps from one or more previous bitmap sets. In one embodiment, bitmaps are combined by performing an AND operation. At block 1046, bitmap combinations are scored. Scoring may include computing compression scores and I/O utilization scores for each bitmap combination.

At block 1048, cloud storage appliance determines whether all of the data chunks in a current run have been processed. In one embodiment, a run may include up to 128 data chunks that are processed in parallel. If not all data chunks have been processed, the method continues to block 1050, and the method proceeds with the next data chunk. The method then returns to block 1032 and repeats the subsequent operations for the new data chunk.

If at block 1048 the cloud storage appliance determines that all data chunks in the run have been processed, the method continues to block 1052. At block 1052, the cloud storage appliance selects reference chunks or reference chunk pairs having the best scores for the data chunk. These are the reference chunks or reference chunk pairs having the best scoring bitmaps. In one embodiment, a reference chunk pair that has the best score is the reference chunk pair with the highest compression score, the lowest retrieval load score and the lowest I/O utilization score.

FIG. 10C is a flow diagram illustrating another embodiment of a method 1060 for selecting optimal reference chunks to use for compressing one or more data chunks. Method 1060 may be performed by processing logic that may comprise hardware (e.g., circuitry, dedicated logic, programmable logic, microcode, etc.), software (e.g., instructions run on a processing device to perform hardware simulation), or a combination thereof. In one embodiment, method 1060 is performed by a cloud storage appliance (e.g., cloud storage appliance 110 of FIG. 1). Alternatively, method 1060 may be performed by a cloud storage agent. Method 1060 may be performed, for example, by a reference choosing module running on a cloud storage appliance or cloud storage agent. For convenience, method 1060 will be discussed with reference to a cloud storage appliance. However, it should be understood that method 1060 may also be performed by other software and/or hardware elements.

Referring to FIG. 10C, at block 1064 of method 1060 a cloud storage appliance determines available CPU resources and available I/O resources. The cloud storage appliance may also determine available cloud resources. At block 1068, the cloud storage appliance sets a CPU budget and an I/O budget based on the available CPU resources and the available I/O resources. Additionally, if cloud storage retrieval is enabled for obtaining reference chunks during compression, a cloud budget is also determined based on the available cloud resources. A retrieval load budget may also be set based on an amount of available network resources. In one embodiment, the retrieval load budget is a fixed value. Alternatively, the retrieval load budget changes based on the available network resources.

At block 1070, the cloud storage appliance enables or disables heuristics based on the CPU budget and the I/O budget. For example, at a lowest CPU budget setting, the cloud storage appliance generate bitmaps having 1 bit per region, and I/O utilization scores may not be computed. At a higher CPU budget, the cloud storage appliance may use 2 bits per region, and I/O utilization scores may be computed. At a still higher CPU budget, the cloud storage appliance may generate bitmaps having 4 bits per region, and budget determiner 558 may enable an anti-aliasing heuristic (as described with reference to FIG. 8B). At block 1071, the cloud storage appliance computes compression scores, retrieval load scores and I/O utilization scores for reference chunks using the enabled heuristics.

At block 1072, the cloud storage appliance weights the compression scores, retrieval load scores and I/O utilization scores for reference chunks based on the budgets. For example, if the CPU budget is higher than the I/O budget and the retrieval load budget, then the compression scores may be weighted more heavily than the retrieval load scores and I/O utilization scores.

At block 1074, the cloud storage appliance determines reference chunks to compress data chunks against using the weighted compression scores, retrieval load scores and I/O utilization scores. At block 1080, the cloud storage appliance fetches the determined reference chunks. The cloud storage appliance may then compress the data chunks using the retrieved reference chunks.

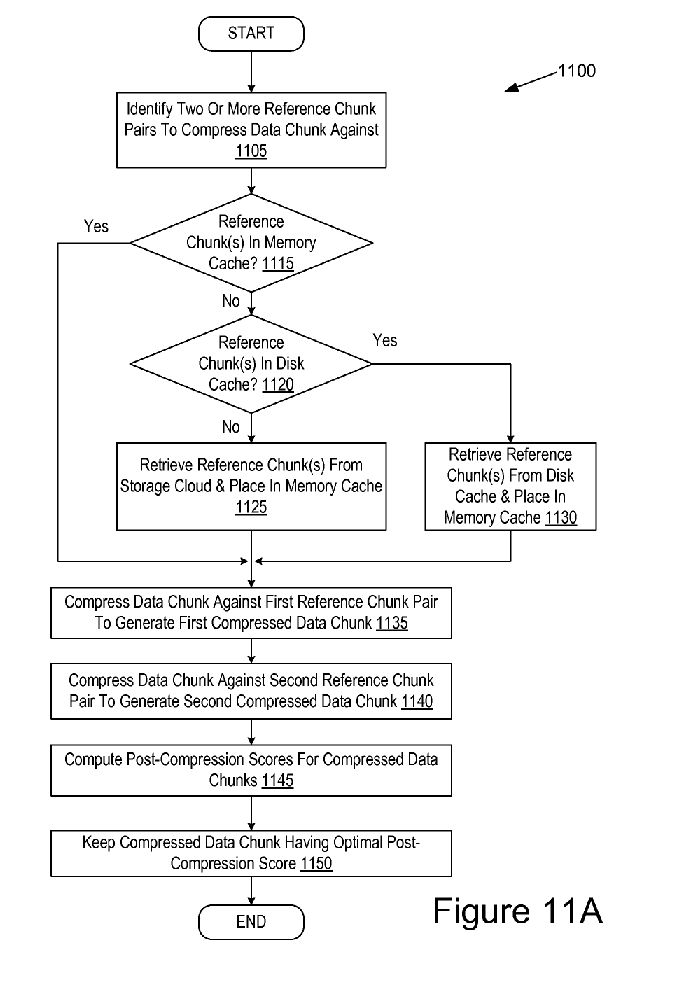

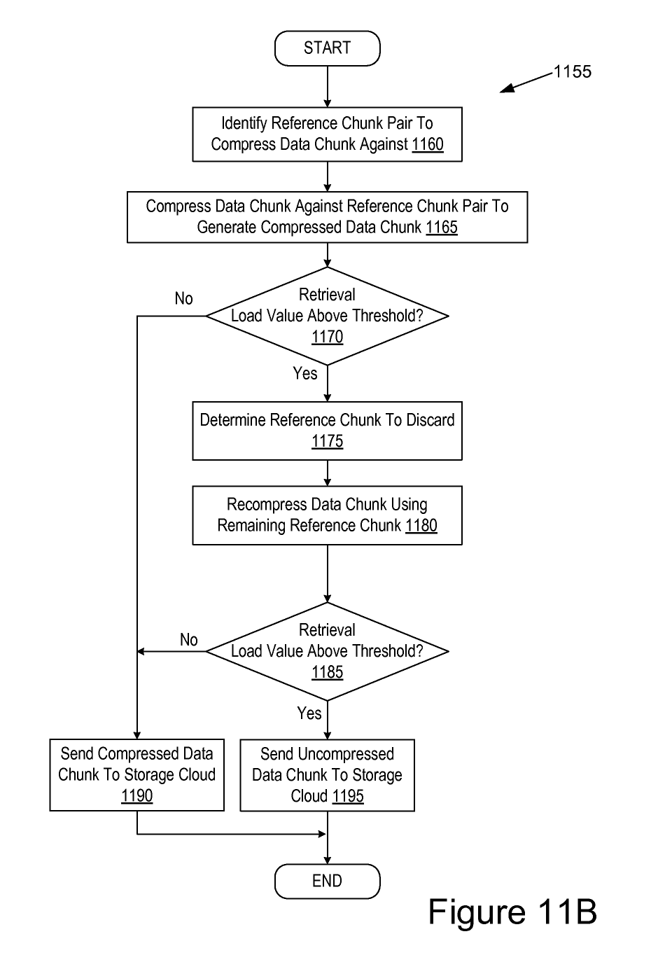

FIG. 11A is a flow diagram illustrating another embodiment of a method 1100 for selecting optimal reference chunks to use for compressing a data chunk. Method 1100 may be performed by processing logic that may comprise hardware (e.g., circuitry, dedicated logic, programmable logic, microcode, etc.), software (e.g., instructions run on a processing device to perform hardware simulation), or a combination thereof. In one embodiment, method 1100 is performed by a cloud storage appliance (e.g., cloud storage appliance 110 of FIG. 1). Alternatively, method 1100 may be performed by a cloud storage agent. Method 1100 may be performed, for example, by a reference choosing module running on a cloud storage appliance or cloud storage agent. For convenience, method 1100 will be discussed with reference to a cloud storage appliance. However, it should be understood that method 1100 may also be performed by other software and/or hardware elements.

Referring to FIG. 11A, at block 1105 of method 1100 a cloud storage appliance identifies two or more reference chunk pairs to compress a data chunk against. At block 1115, the cloud storage appliance determines whether the reference chunks are in a memory cache. This may be determined by querying the memory cache or based on data included in fingerprint match information. If the reference chunks are in a memory cache, the method continues to block 1135. If any of the reference chunks are not in the memory cache, the method continues to block 1120.

At block 1120, the cloud storage appliance determines whether the reference chunks are in a disk cache. If the reference chunks are in a disk cache, the method proceeds to block 1130, and the reference chunks are retrieved from the disk cache and placed in the memory cache. If the reference chunks are not in the disk cache, the method continues to block 1125, and the reference chunks are retrieved from the storage cloud and placed in the memory cache. In one embodiment, reference chunks are not retrieved from the storage cloud for compression. In such an embodiment, all identified reference chunks would be either in the memory cache or the disk cache.

At block 1135, the cloud storage appliance compresses the data chunk against the first reference chunk pair to generate a first compressed data chunk. At block 1140, the cloud storage appliance compresses the data chunk against the second reference chunk pair to generate a second compressed data chunk. The cloud storage appliance may also compress the data chunk against additional reference chunk pairs if additional reference chunk pairs have been retrieved.

At block 1145, the cloud storage appliance computes post-compression scores for the compressed data chunks. The post-compression scores may include a compressed data chunk size score and/or a retrieval load score. In one embodiment, the post-compression scores are a weighted combination of the compressed data chunk size score and the retrieval load score. The weighting can be used to determine which compressed data chunk has an optimal combination of size and retrieval load value. At block 1150, the cloud storage appliance discards all but one compressed data chunk. The compressed data chunk having the optimal post-compression score is kept, and may then be sent to the storage cloud. In one embodiment, any compressed data chunks having a retrieval load score that exceeds a retrieval load threshold are also discarded, regardless of the combined post-compression score.

FIG. 11B is a flow diagram illustrating another embodiment of a method 1155 for compressing a data chunk. Method 1155 may be performed by processing logic that may comprise hardware (e.g., circuitry, dedicated logic, programmable logic, microcode, etc.), software (e.g., instructions run on a processing device to perform hardware simulation), or a combination thereof. In one embodiment, method 1155 is performed by a cloud storage appliance (e.g., cloud storage appliance 110 of FIG. 1). Alternatively, method 1155 may be performed by a cloud storage agent. Method 1155 may be performed, for example, by a reference choosing module running on a cloud storage appliance or cloud storage agent. For convenience, method 1155 will be discussed with reference to a cloud storage appliance. However, it should be understood that method 1155 may also be performed by other software and/or hardware elements.

Referring to FIG. 11B, at block 1160 of method 1155 a cloud storage appliance identifies a reference chunk pair to compress a data chunk against. At block 1165, the cloud storage appliance compresses the data chunk against the reference chunk pair to generate a compressed data chunk. At block 1170, the cloud storage appliance computes a retrieval load value for the compressed data chunk, and determines whether the retrieval load value exceeds a retrieval load threshold. If the retrieval load value exceeds the retrieval load threshold, the method continues to block 1175. Otherwise, the method proceeds to block 1190.

At block 1175, the cloud storage appliance determines a reference chunk to discard. In one embodiment, the reference chunk having the lower retrieval load value is discarded. In one embodiment, each reference chunk is associated with a fingerprint match score. The fingerprint match score identifies the number of regions of the data chunk that had fingerprints that matched regions of the reference chunk. In one embodiment, the reference chunk's bitmap is maintained and used for the fingerprint match score. The cloud storage appliance may compute a ratio of the fingerprint match score to the retrieval load value for each reference chunk. The cloud storage appliance may then discard the reference chunk having the lower ratio of fingerprint match score to retrieval load value. For example, a first reference chunk with a fingerprint match score of 5 and a retrieval load value of 100 kb may have a ratio of 1:20 and a second reference chunk with a fingerprint match score of 3 and a load value of 300 would have a ratio of 1:100. In this example, the second reference chunk would be discarded.

At block 1180, the cloud storage appliance recompresses the data chunk using the remaining reference chunk. At block 1185, the cloud storage appliance again computes the compressed data chunk's retrieval load value and compares it to the retrieval load threshold. If the retrieval load value still exceeds the retrieval load threshold, the method continues to block 1195. Otherwise, the method proceeds to block 1190.

At block 1190, the compressed data chunk is sent to the storage cloud. At block 1195, the uncompressed data chunk is sent to the storage cloud. Sending the compressed or uncompressed data chunk to the storage cloud may include placing the compressed or uncompressed data chunk in a cloud file and sending the cloud file to the storage cloud.

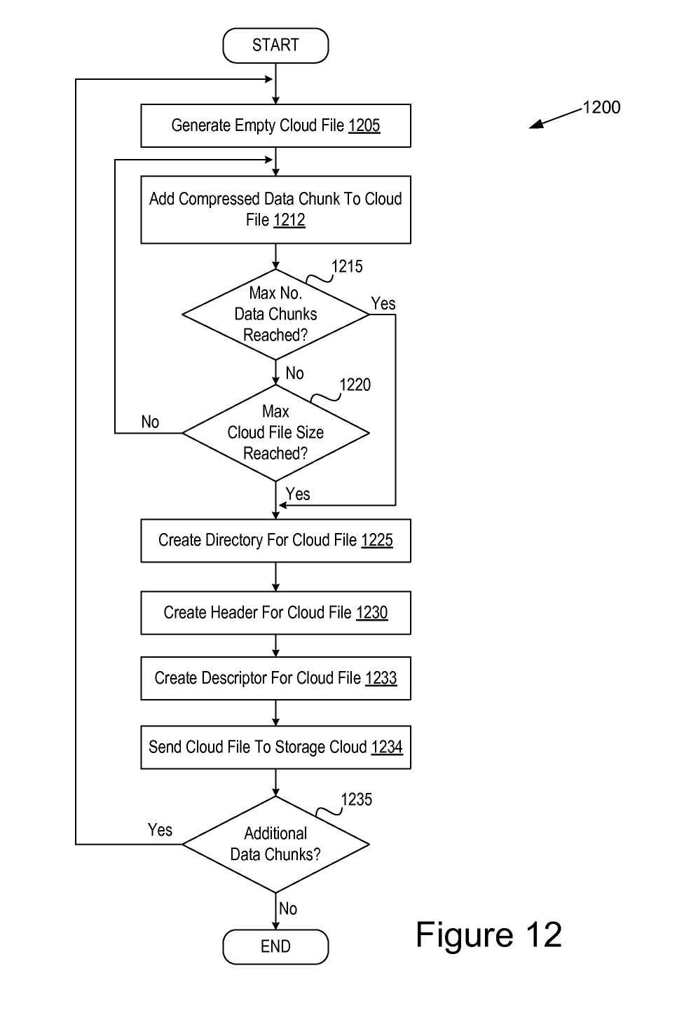

FIG. 12 is a flow diagram illustrating one embodiment of a method 1200 for generating cloud files. Method 1200 may be performed by processing logic that may comprise hardware (e.g., circuitry, dedicated logic, programmable logic, microcode, etc.), software (e.g., instructions run on a processing device to perform hardware simulation), or a combination thereof. In one embodiment, method 1200 is performed by a cloud storage appliance (e.g., cloud storage appliance 110 of FIG. 1). Alternatively, method 1200 may be performed by a cloud storage agent. Method 1200 may be performed, for example, by a compression pipeline running on a cloud storage appliance or cloud storage agent. For convenience, method 1200 will be discussed with reference to a cloud storage appliance. However, it should be understood that method 1200 may also be performed by other software and/or hardware elements.

Referring to FIG. 12, at block 1205 of method 1200 a cloud storage appliance generates an empty cloud file. At block 1212, the cloud storage appliance adds a compressed data chunk to the cloud file. At block 1215, the cloud storage appliance determines whether a maximum number of compressed data chunks have been added to the cloud file. If the maximum number of data chunks have been added to the cloud file, the method proceeds to block 1225. Otherwise, the method continues to block 1220.

At block 1220, the cloud storage appliance determines whether a maximum cloud file size has been reached. If the cloud file has reached the maximum cloud file size, the method proceeds to block 1225. If the cloud file has not reached the maximum cloud file size, the method returns to block 1212, and another compressed data chunk is added to the cloud file.

At block 1225, the cloud storage appliance generates a directory for the cloud file. The directory identifies the number and/or size of the data chunks in the cloud file, as well as the location of each of the data chunks in the cloud file. At block 1230, the cloud storage appliance generates a header for the cloud file. The header identifies the location within the cloud file of the directory, and may additionally identify a size of the directory. At block 1233, the cloud storage appliance generates a descriptor for the cloud file. The descriptor identifies all of the data chunks that are referenced by data chunks included in the cloud file.

At block 1234, the cloud storage appliance sends the cloud file to the storage cloud. At block 1235, the cloud storage appliance determines whether there are additional data chunks that need to be stored in the storage cloud. If there are additional data chunks that need to be stored in the storage cloud, the method returns to block 1205, and another cloud file is generated. Otherwise, the method ends.

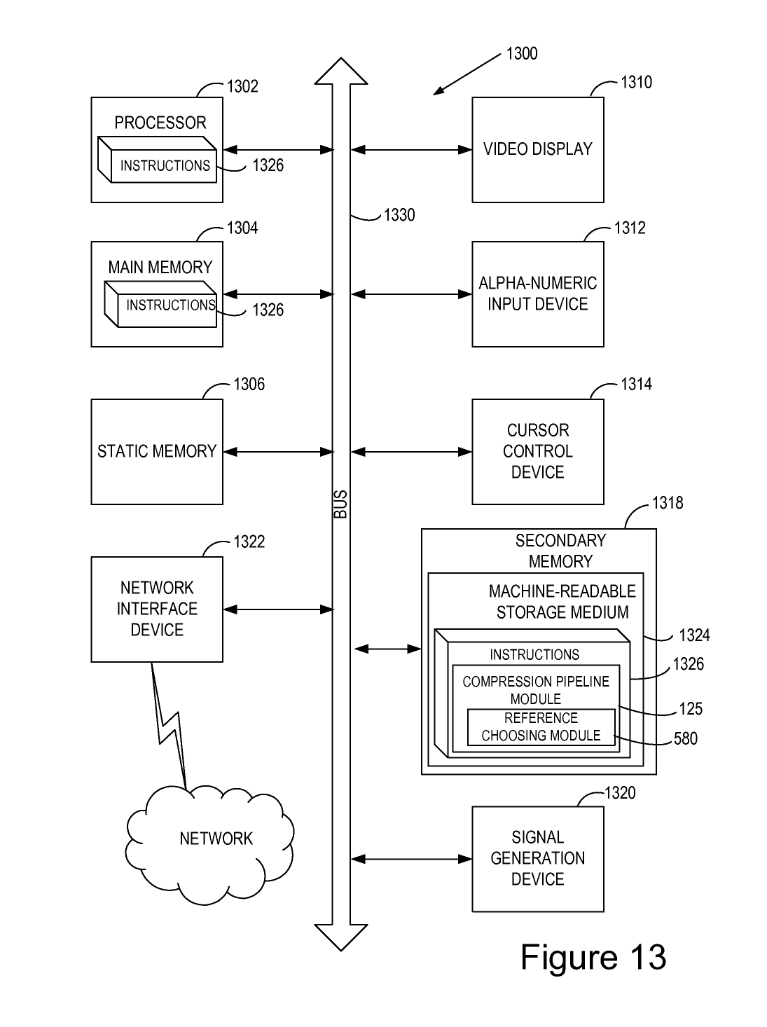

FIG. 13 illustrates a diagrammatic representation of a machine in the exemplary form of a computer system 1300 within which a set of instructions, for causing the machine to perform any one or more of the methodologies discussed herein, may be executed. In alternative embodiments, the machine may be connected (e.g., networked) to other machines in a Local Area Network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein. In one embodiment, the computer system 1300 corresponds to cloud storage appliance 110 of FIG. 1. Alternatively, the computer system 1300 may correspond to client 230 of FIG. 2.

The exemplary computer system 1300 includes a processor 1302, a main memory 1304 (e.g., read-only memory (ROM), flash memory, dynamic random access memory (DRAM) such as synchronous DRAM (SDRAM) or Rambus DRAM (RDRAM), etc.), a static memory 1306 (e.g., flash memory, static random access memory (SRAM), etc.), and a secondary memory 1318 (e.g., a data storage device), which communicate with each other via a bus 1330.

Processor 1302 represents one or more general-purpose processing devices such as a microprocessor, central processing unit, or the like. More particularly, the processor 1302 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 1302 may also be one or more special-purpose processing devices such as an application specific integrated circuit (ASIC), a field programmable gate array (FPGA), a digital signal processor (DSP), network processor, or the like. Processor 1302 is configured to execute instructions 1326 (e.g., processing logic) for performing the operations and steps discussed herein.

The computer system 1300 may further include a network interface device 1322. The computer system 1300 also may include a video display unit 1310 (e.g., a liquid crystal display (LCD) or a cathode ray tube (CRT)), an alphanumeric input device 1312 (e.g., a keyboard), a cursor control device 1314 (e.g., a mouse), and a signal generation device 1320 (e.g., a speaker).

The secondary memory 1318 may include a machine-readable storage medium (or more specifically a computer-readable storage medium) 1324 on which is stored one or more sets of instructions 1326 (e.g., software) embodying any one or more of the methodologies or functions described herein. The instructions 1326 may also reside, completely or at least partially, within the main memory 1304 and/or within the processing device 1302 during execution thereof by the computer system 1300, the main memory 1304 and the processing device 1302 also constituting machine-readable storage media.

The machine-readable storage medium 1324 may also be used to store the compression pipeline module 125 of FIG. 1 and/or reference choosing module 580 of FIG. 5, and/or a software library containing methods that call the compression pipeline module and/or reference choosing module. While the machine-readable storage medium 1324 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the present invention. The term “machine-readable storage medium” shall accordingly be taken to include, but not be limited to, solid-state memories, and optical and magnetic media.

It is to be understood that the above description is intended to be illustrative, and not restrictive. Many other embodiments will be apparent to those of skill in the art upon reading and understanding the above description. Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense. The scope of the invention should, therefore, be determined with reference to the appended claims, along with the full scope of equivalents to which such claims are entitled.

What is claimed is:

1. A method comprising:
separating a point-in-time copy of a storage system into payload data chunks and metadata data chunks;
identifying a plurality of payload data chunks that have not been saved to a storage cloud;
compressing the plurality of payload data chunks;
grouping the plurality of compressed payload data chunks into one or more cloud files, wherein each of the one or more cloud files is formatted for storage on the storage cloud; and
sending the one or more cloud files to the storage cloud.

2. The method of claim 1, wherein the grouping comprises:
generating an empty cloud file, the empty cloud file being a container for holding compressed data chunks;
adding one or more compressed data chunks to the empty cloud file;
determining whether a quantity of compressed data chunks in the cloud file meets a first threshold;
determining whether a size of the cloud file meets a second threshold; and
if the quantity of compressed data chunks in the cloud file does not meet the first threshold and the size of the cloud file does not meet the second threshold, adding one or more additional compressed data chunks to the cloud file.

3. The method of claim 1, wherein compressing the plurality of data chunks comprises, for each data chunk:
selecting one or more reference chunks to compress the data chunk against, wherein each reference chunk is a previously compressed data chunk that has been stored in the storage cloud;
fetching the selected one or more reference chunks from a local cache; and
replacing at least a portion of the data chunk with references to the selected one or more reference chunks.

4. The method of claim 3, wherein at most two reference chunks are selected to compress the data chunk against.

5. The method of claim 1, wherein each cloud file includes a plurality of compressed data chunks, a directory that identifies where in the cloud file each of the plurality of compressed data chunks is located, and a header that identifies where in the cloud file the directory is located.

6. The method of claim 1, further comprising:
after all of the payload data chunks are compressed and sent to the storage cloud, performing the following:
identifying a plurality of metadata data chunks that have not been saved to the storage cloud;
compressing the plurality of metadata data chunks;
grouping the plurality of compressed metadata data chunks into one or more cloud files; and
sending the one or more cloud files to the storage cloud.

7. The method of claim 1, wherein the metadata data chunks are divided into first layer metadata data chunks and second layer metadata data chunks, and wherein all of the first layer metadata data chunks are compressed and sent to the storage cloud before any of the second layer metadata data chunks are compressed.

8. A computer readable storage medium including instructions that, when executed by a processing device, cause the processing device to perform a method comprising:
separating a point-in-time copy of a storage system into payload data chunks and metadata data chunks;
identifying a plurality of payload data chunks that have not been saved to a storage cloud;
compressing the plurality of payload data chunks;
grouping the plurality of compressed payload data chunks into one or more cloud files, wherein each of the one or more cloud files is formatted for storage on the storage cloud; and
sending the one or more cloud files to the storage cloud.

9. The computer readable storage medium of claim 8, wherein the grouping comprises:
generating an empty cloud file, the empty cloud file being a container for holding compressed data chunks;
adding one or more compressed data chunks to the empty cloud file;
determining whether a quantity of compressed data chunks in the cloud file meets a first threshold;
determining whether a size of the cloud file meets a second threshold; and
if the quantity of compressed data chunks in the cloud file does not meet the first threshold and the size of the cloud file does not meet the second threshold, adding one or more additional compressed data chunks to the cloud file.

10. The computer readable storage medium of claim 8, wherein compressing the plurality of data chunks comprises, for each data chunk:
selecting one or more reference chunks to compress the data chunk against, wherein each reference chunk is a previously compressed data chunk that has been stored in the storage cloud;
fetching the selected one or more reference chunks from a local cache; and
replacing at least a portion of the data chunk with references to the selected one or more reference chunks.

11. The computer readable storage medium of claim 10, wherein at most two reference chunks are selected to compress the data chunk against.

12. The computer readable storage medium of claim 8, wherein each cloud file includes a plurality of compressed data chunks, a directory that identifies where in the cloud file each of the plurality of compressed data chunks is located, and a header that identifies where in the cloud file the directory is located.

13. The computer readable storage medium of claim 8, the method further comprising:
after all of the payload data chunks are compressed and sent to the storage cloud, performing the following:
identifying a plurality of metadata data chunks that have not been saved to the storage cloud;
compressing the plurality of metadata data chunks;
grouping the plurality of compressed metadata data chunks into one or more cloud files; and
sending the one or more cloud files to the storage cloud.

14. The computer readable storage medium of claim 8, wherein the metadata data chunks are divided into first layer metadata data chunks and second layer metadata data chunks, and wherein all of the first layer metadata data chunks are compressed and sent to the storage cloud before any of the second layer metadata data chunks are compressed.

15. A storage appliance comprising:
a memory to store instructions for a compression pipeline module; and
a processing device to execute the instructions, wherein the instructions cause the processing device to:
separate a point-in-time copy of a storage system into payload data chunks and metadata data chunks;
identify a plurality of payload data chunks that have not been saved to a storage cloud;
compress the plurality of payload data chunks;
group the plurality of compressed payload data chunks into one or more cloud files, wherein each of the one or more cloud files is formatted for storage on the storage cloud; and
send the one or more cloud files to the storage cloud.

16. The storage appliance of claim 15, wherein to group the plurality of compressed payload data chunks into the one or more cloud files, the processing device:
generates an empty cloud file, the empty cloud file being a container for holding compressed data chunks;
adds one or more compressed data chunks to the empty cloud file;
determines whether a quantity of compressed data chunks in the cloud file meets a first threshold;
determines whether a size of the cloud file meets a second threshold; and
if the quantity of compressed data chunks in the cloud file does not meet the first threshold and the size of the cloud file does not meet the second threshold, adds one or more additional compressed data chunks to the cloud file.

17. The storage appliance of claim 15, wherein compressing the plurality of data chunks comprises, for each data chunk:
selecting one or more reference chunks to compress the data chunk against, wherein each reference chunk is a previously compressed data chunk that has been stored in the storage cloud;
fetching the selected one or more reference chunks from a local cache; and
replacing at least a portion of the data chunk with references to the selected one or more reference chunks.

18. The storage appliance of claim 17, wherein at most two reference chunks are selected to compress the data chunk against.

19. The storage appliance of claim 15, wherein each cloud file includes a plurality of compressed data chunks, a directory that identifies where in the cloud file each of the plurality of compressed data chunks is located, and a header that identifies where in the cloud file the directory is located.

20. The storage appliance of claim 15, further comprising the instructions to cause the processing device to perform the following after all of the payload data chunks are compressed and sent to the storage cloud:
identify a plurality of metadata data chunks that have not been saved to the storage cloud;
compress the plurality of metadata data chunks;
group the plurality of compressed metadata data chunks into one or more cloud files; and
send the one or more cloud files to the storage cloud.

21. The storage appliance of claim 15, wherein the metadata data chunks are divided into first layer metadata data chunks and second layer metadata data chunks, and wherein all of the first layer metadata data chunks are compressed and sent to the storage cloud before any of the second layer metadata data chunks are compressed.
